(19) United States
(12) Patent Application Publication
(10) Pub. No.: US 2026/0337369 A1
(43) Pub. Date: Oct. 29, 2026

(54) MOLDED ARTICLE, METHOD FOR MANUFACTURING LASER-MARKED MOLDED ARTICLE, AND LASER MARKING METHOD

(71) Applicant: ASAHI KASEI KABUSHIKI KAISHA, Chiyoda-ku, Tokyo (JP)

(72) Inventor: Kenta HIWATASHI, Chiyoda-ku, Tokyo (JP)

(73) Assignee: ASAHI KASEI KABUSHIKI KAISHA, Chiyoda-ku, Tokyo (JP)

(21) Appl. No.: 19/145,911

(22) PCT Filed: Nov. 16, 2023
(86) PCT No.: PCT/JP2023/041317

§ 371 Date: Jul. 4, 2025

(30) Foreign Application Priority Data
Jan. 13, 2023 (JP) 2023-004119

(51) Int. Cl. C08K 3/013; B41M 5/26; C08K 3/22; C08K 5/00; C08K 5/53

(52) U.S. Cl. CPC C08K 3/013; B41M 5/267; C08K 3/22; C08K 3/2279; C08K 5/0066; C08K 5/53; C08K 2003/2241; C08K 2201/005

(57) ABSTRACT

The present disclosure is directed to providing a molded article with clearly printed markings made by laser marking, a method for manufacturing the molded article, and a laser marking method that enables clear printed markings. The molded article of the present disclosure is a molded article formed by molding a resin composition that contains a thermoplastic resin (A) and titanium oxide (B) with an average particle size of 1 μm or less, has an identification portion having a color tone different from the color tone of the surrounding portion, wherein a light reflectance at a wavelength of 355 nm is 17% or less when the resin composition is molded into a molded product with a thickness of 50 μm, and the protrusion height of the identification portion is 6.6 μm or less.

### TECHNICAL FIELD

The present disclosure relates to a molded article, a method for manufacturing a laser-marked molded article, and a laser marking method.

### BACKGROUND

Conventionally, methods such as attaching printed labels or various printing techniques, e.g., pad printing and silk printing, have been used as methods for providing information, such as product names, serial numbers, and precautions, on resin molded articles.

However, these recording methods have problems, such as printing defects due to ink scattering, difficulties in printing on uneven surfaces, and difficulties in printing fine characters. Additionally, the label-attaching method also has restrictions, including the requirement for a smooth surface on the molded article. Therefore, in recent years, laser marking technology (hereinafter referred to as “laser marking”) has been increasingly used as the methodology to solve these problems. Laser marking is a highly useful method capable of performing marking with excellent reproducibility and high speed without the above-described defects.

However, laser marking is not necessarily a technique that can be directly applied to all resins, and in general, improvements in laser markability are being investigated through modifications to the resin per se or the various additives.

For example, PTL 1 proposes an improvement in the marking characteristics of polyamide colored black with carbon black.

Additionally, PTL 2 proposes a polyamide resin composition with excellent laser marking characteristics.

Furthermore, PTL 3 proposes a resin composition made mainly of a thermoplastic polyester resin, brominated polystyrene, antimony compounds, titanium dioxide, and glass fibers, which undergoes laser marking using a fiber laser (wavelength: 1064 nm), resulting in a significant color contrast with the surrounding portion.

### CITATION LIST

### Patent Literature

PTL 1: WO 2022/191310 A1
PTL 2: JP 2009-035656 A
PTL 3: JP 2013-151619 A

### SUMMARY

### Technical Problem

However, the technology of PTL 1 is limited to clear marking of black-colored articles, failing to achieve improved clarity in markings on lightly colored, gray, or colored resins. Additionally, laser marking is often used not only for printing a large amount of text information printed on labels but also for printing complex figures, such as QR Codes® that store large amounts of information for traceability. Thus, the technology of PTL 2 still has room for improvement in terms of the clarity of printed markings.

Furthermore, polyamides often contain filling agents, generically referred to as fillers, to provide reinforcement effects, reduce shrinkage, and impart flame retardancy or other mechanical properties and functionalities. It is generally known that fillers in a polyamide tend to be exposed on the surface. When fillers are exposed on the surface, the color tone changes compared to cases where no fillers are added. Consequently, a polyamide containing fillers poses a challenge to further reducing clarity in laser marking.

Although PTL 3 is a technology that provides high color contrast in the printed portions, it involves the inclusion of antimony compounds and brominated polystyrene, which are known to have adverse effects on the environment and human health, raising concerns about the safety. The use of such substances as additives in resins is prohibited or considered for restriction. Therefore, there is a demand to achieve excellent laser marking properties without using such substances.

The present disclosure has been made in view of the aforementioned circumstances, and it is directed to providing a molded article with clearly printed markings made by laser marking, a method for producing such a molded article, and a laser marking method that can provide clearly printed markings.

### Solution to Problem

Specifically, the present disclosure is as follows.

[1]

A molded article formed by molding a resin composition that contains a thermoplastic resin (A) and titanium oxide (B) with an average particle size of 1 μm or less and is free of antimony-based oxides, the molded article comprising
an identification portion having a color tone different from a color tone of a surrounding portion,
wherein a light reflectance at a wavelength of 355 nm is 17% or less when the resin composition is molded into a molded product with a thickness of 50 μm, and
a protrusion height of the identification portion is 6.6 μm or less.
   [2]

The molded article according to [1], wherein the thermoplastic resin (A) comprises a polyamide-based resin (A1) and/or a polyester-based resin (A2).

[3]

The molded article according to [2], wherein the polyamide-based resin (A1) is a semi-aromatic polyamide (A1-2) containing an aromatic ring in a backbone thereof, or an alloy of the semi-aromatic polyamide (A1-2) and an aliphatic polyamide (A1-1).

[4]

The molded article according to [3], wherein the semi-aromatic polyamide (A1-2) contains 10 mol % or more of isophthalic acid units per 100 mol % of a sum of all constituting dicarboxylic acid units.

[5]

The molded article according to any one of [1] to [4], wherein a glass transition temperature of the resin composition is 90° C. or higher.

[6]

The molded article according to any one of [1] to [5], wherein a crystallization peak temperature of the resin composition is 240° C. or lower.

[7]

The molded article according to any one of [1] to [6], wherein the resin composition further comprises a filler (C).

[8]

The molded article according to [7], wherein the resin composition contains the filler (C) in an amount of more than 0.0 parts by mass and 150.0 parts by mass or less per 100 parts by mass of the thermoplastic resin (A).

[9]

The molded article according to [7] or [8], wherein the filler (C) is at least one selected from the group consisting of glass fibers, calcium carbonate, talc, mica, wollastonite, and milled fiber.

[10]

The molded article according to any one of [1] to [9], wherein the resin composition further comprises a flame retardant (D).

[11]

The molded article according to [10], wherein the flame retardant (D) is at least one selected from the group consisting of a phosphinate salt and a diphosphinate salt.

[12]

The molded article according to [11], wherein the phosphinate salt is a compound represented by the following formula (I), and the diphosphinate salt is a compound represented by the following formula (II):

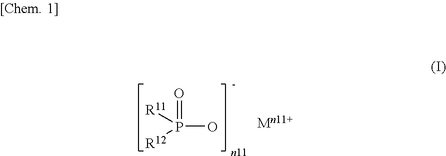

in the formula (I), R¹¹ and R¹² are each independently an alkyl group with 1 or more and 6 or fewer carbon atoms or an aryl group with 6 or more and 10 or fewer carbon atoms, Mⁿ¹¹⁺ is an n11-valent metal ion, M is an element belonging to Group 2 or Group 15 of the periodic table, a transition element, zinc, or aluminum, n11 is 2 or 3, and respective occurrences of R¹¹ and R¹² may each be identical or different, and

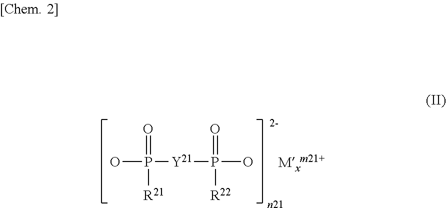

in the formula (II), R²¹ and R²² are each independently an alkyl group with 1 or more and 6 or fewer carbon atoms or an aryl group with 6 or more and 10 or fewer carbon atoms, Y²¹ is an alkylene group with 1 or more and 10 or fewer carbon atoms or an arylene group with 6 or more and 10 or fewer carbon atoms, M′ₓ^{m21+} is an m21-valent metal ion, M′ is an element belonging to Group 2 or Group 15 of the periodic table, a transition element, zinc, or aluminum, n21 is an integer of 1 or more and 3 or less, when n21 is 2 or 3, respective occurrences of R²¹, R²², and Y²¹ may each be identical or different, m21 is 2 or 3, x is 1 or 2, when x is 2, occurrences of M′ may each be identical or different, and n21, x, and m21 are integers that satisfy the relationship formula: 2×n21=m21×x.

The molded article according to any one of [1] to [12], wherein the resin composition comprises a colorant (E), and a lightness (L* value) of the molded article is 25 or more.

The molded article according to any one of [1] to [13], wherein the resin composition contains the titanium oxide (B) in an amount of 0.5 parts by mass or more and 10.0 parts by mass or less per 100 parts by mass of the thermoplastic resin (A).

The molded article according to any one of [1] to [14], wherein a developed interfacial area ratio Sdr of an interface as defined in ISO 25178 of the identification portion is 0.01 or more and 2.0 or less.

The molded article according to any one of [1] to [15], wherein the molded article is a housing for a magnetic switch, a housing for a breaker, or a molded article for a connector.

A method for manufacturing a laser-marked molded article comprising:
performing laser marking on a molded article formed by molding a resin composition containing a thermoplastic resin (A),
wherein the resin composition is a composition having a light reflectance at a wavelength of 355 nm of 17% or less when formed into a molded product with a thickness of 50 μm.

A method of laser marking a molded article formed by molding a resin composition containing a thermoplastic resin (A),
wherein the resin composition is a composition having a light reflectance at a wavelength of 355 nm of 17% or less when formed into a molded product with a thickness of 50 μm.

### Advantageous Effect

According to the molded article and manufacturing method of the above aspect, a molded article with clearly printed markings made by laser marking can be obtained. According to the laser marking method of the present disclosure, a molded article with clearly printed markings can be obtained.

### BRIEF DESCRIPTION OF THE DRAWINGS

FIG. 1 is a schematic diagram illustrating a method for measuring the light absorptivity;

FIG. 2 illustrates the measurement results of the light reflectance (%) of Production Examples 12 and 15; and

FIG. 3 illustrates the measurement results of the light transmittance (%) of Production Examples 12 and 15.

### DETAILED DESCRIPTION

Hereinafter, an embodiment for embodying the present disclosure (hereinafter referred to merely as “the present embodiment”) will be described in detail. Note that the present embodiment set forth below is an illustrative embodiment for describing the present disclosure and is not intended to limit the present disclosure to the following matter. The present disclosure can be implemented with appropriate modifications that do not deviate from the gist thereof.

In this specification, the “term polyamide” refers to a polymer having amide (—NHCO—) groups in the main chain.

### <<Molded Article>>

The molded article of the present embodiment is a molded article formed by molding a resin composition containing a thermoplastic resin (A) and titanium dioxide (B) with an average particle size of 1 μm or less and free of antimony-based oxides.

The molded article of the present embodiment has an identification portion with a different color tone from the surrounding portion. In this specification, the term “identification portion” refers to a processed portion where a color difference is created between the irradiated and non-irradiated parts due to the color change of the colorant upon exposure to laser or heat, making it clearly distinguishable.

Particularly, the identification portion provided to the molded article of the present embodiment is preferably a printed portion provided made by laser marking.

Furthermore, in this specification, the term “different color tone” may refer to a color difference ΔE* of 3 or more (preferably 5 or more, more preferably 10 or more) between the surrounding portion (unprinted portion) and the identification portion (printed portion) as measured using the method described in the examples below.

The term “surrounding portion” refers to an unprinted portion with a lightness (L* value) of 40 or more, preferably 50 or more, and more preferably 60 or more, as measured using the method described in the examples.

The resin composition has a light reflectance of preferably 17% or less, more preferably 15% or less, even more preferably 13% or less, still even more preferably 12% or less, and particularly preferably 11% or less at a wavelength of 355 nm when formed into a molded product with a thickness of 50 μm. The light reflectance may be more than 0%, may be 1% or more, or may be 2% or more. The lower the light reflectance, the more the laser beam can penetrate inside the molded product, thereby increasing the proportion of the colorant that changes color due to the laser beam, resulting in excellent clarity of printed markings.

Additionally, the resin composition has a light transmittance of preferably 98% or less, more preferably 95% or less, even more preferably 90% or less, further preferably 85% or less, and particularly preferably 80% or less at a wavelength of 355 nm when formed into a molded product with a thickness of 50 μm. The lower the light absorptivity, the more the laser beam can penetrate inside the molded product, increasing the proportion of the colorant that changes color due to the laser beam, resulting in excellent clarity of printed markings.

The light absorptivity can be calculated using the following formula:

Light absorptivity (%)=100%−light transmittance (%)−light reflectance (%)

The test piece for measuring the light reflectance with a thickness of 50 μm may be a test piece prepared using the method described in the examples below. Examples of the preparation methods include hot pressing and T-die extrusion film formation. When the test piece is prepared using hot pressing, it is preferable to adjust the thickness to the specified value using a spacer.

The light reflectance at a certain wavelength can be measured using a spectrophotometer. More specifically, it is preferable to use a spectrophotometer (V670) manufactured by JASCO Corporation, combined with an integrating sphere (ILN-725) for measurement. Since the light transmitted through the test piece is scattered, it is preferable to use an integrating sphere to capture the scattered light for measurement.

The light absorptivity at a certain wavelength can be calculated by measuring the transmittance and reflectance at that wavelength using the above-described spectrophotometer and subtracting these values from 100%.

In the molded article of the present embodiment, the developed interfacial area ratio Sdr of the interface as defined in ISO 25178 of the identification portion is preferably 0.01 or more and 2.00 or less, more preferably 0.01 or more and 1.50 or less, even more preferably 0.01 or more and 1.00 or less, and particularly preferably 0.01 or more and 0.5 or less.

If the developed interfacial area ratio Sdr exceeds the above numerical range, light scattering increases, causing the color development of the identification portion to become unclear. It is preferable to keep the developed interfacial area ratio Sdr low (for example, the above-described upper limit or less), because light scattering is suppressed.

The developed interfacial area ratio Sdr is one of the parameters defining the surface roughness of an object as defined in ISO 25178.

The above-described developed interfacial area ratio Sdr can be measured in accordance with ISO 25178, It can be measured using a non-contact method using a laser, for example.

More specifically, the developed interfacial area ratio Sdr can be measured using a laser microscope (measurement unit: VK-X210, controller: VK-X200) manufactured by Keyence Corporation. The developed interfacial area ratio Sdr as defined in ISO 25178 can be measured by setting a 20× objective lens, moving the measurement instrument to the observation area, and starting the measurement in “Expert” mode.

When three molded products are obtained under the processing conditions of a wavelength of 355 nm, a scanning speed of 1700 mm/sec, and a laser output of 0.5 W, 0.75 W, or 1.0 W, the developed interfacial area ratio Sdr is preferably within the above range for all of the molded products. In this specification, the developed interfacial area ratio may sometimes be referred to as the surface roughness.

In the molded article of the present embodiment, the protrusion height of the identification portion is preferably 6.6 μm or less, more preferably 6.0 μm or less. Additionally, the protrusion height may be 0.001 μm or more, may be 0.01 μm or more, or may be 0.05 μm or more.

Maintaining the protrusion height to the above numerical value or less results in a thinner surface layer covering the identification portion, making the color tone of the identification portion clearer. Furthermore, the clarity and durability of the printed markings made by laser marking on the molded article are improved because fading of the identification portion is prevented when scratched.

The above-described protrusion height is calculated based on the difference between the average height of the identification portion and the average height of the unprocessed portion near the identification portion. The protrusion height can be measured using a non-contact method using a laser, for example.

More specifically, it can be measured using a laser microscope (measurement unit: VK-X210, controller: VK-X200) manufactured by Keyence Corporation. The above-described protrusion height can be measured as the “average step height” by setting the objective lens to 20× magnification, moving the measurement instrument to a position where the edge of the printed markings enters the field of view, making an adjustment so that both the printed portion and the unprocessed portion are within the field of view, and starting the measurement in “Expert” mode.

It is preferable that when three molded products are obtained under the processing conditions of a wavelength of 355 nm, a scanning speed of 1700 mm/sec, and a laser output of 0.5 W, 0.75 W, or 1.0 W, the above protrusion height satisfies the requirements for all of the molded products.

The color difference ΔE between the surrounding portion (unprinted portion) and the identification portion (printed portion) can be measured using the method described in the examples below. For example, it is preferable that when three molded products are obtained under the processing conditions of a wavelength of 355 nm, a scanning speed of 1700 mm/sec, and a laser output of 0.5 W, 0.75 W, or 1.0 W, all of the molded products satisfy the above requirements.

Since the molded article of the present embodiment has the above configuration, excellent clarity of printed markings made by laser marking can be achieved.

Next, the resin composition constituting the molded article of the present embodiment will be described below.

### <Resin Composition>

The resin composition contains a thermoplastic resin (A) and titanium oxide (B).

The resin composition may consist solely of the thermoplastic resin (A) and the titanium oxide (B) or may contain the thermoplastic resin (A), the titanium oxide (B), and at least one selected from the group consisting of a filler (C), a flame retardant (D), and a colorant (E). The resin composition is free of antimony-based oxides.

### [Thermoplastic Resin (A)]

Examples of the thermoplastic resin (A) include polyamide-based resins, polyester-based resins, polyacetal-based resins, polycarbonate-based resins, polyacrylic resins, polyphenylene ether-based resins (including modified polyphenylene ethers obtained by blending or graft polymerization of polyphenylene ether with other resins), polyarylate-based resins, polysulfone-based resins, polyphenylene sulfide-based resins, polyether sulfone-based resins, polyketone-based resins, polyphenylene ether ketone-based resins, polyimide-based resins, polyamide-imide-based resins, polyetherimide-based resins, polyurethane-based resins, polyolefin-based resins (e.g., α-olefin (co)polymers), and various ionomers.

The thermoplastic resin (A) is preferably a crystalline resin having a melting point in the range of preferably 100° C. or higher and 350° C. or lower, more preferably in the range of 150° C. or higher and 350° C. or lower, even more preferably in the range of 200° C. or higher and 350° C. or lower, and particularly preferably in the range of 225° C. or higher and 350° C. or lower, an amorphous resin having a glass transition temperature in the range of preferably 50° C. or higher and 250° C. or lower, more preferably in the range of 60° C. or higher and 250° C. or lower, even more preferably in the range of 80° C. or higher and 250° C. or lower, further more preferably in the range of 85° C. or higher and 250° C. or lower, and particularly preferably in the range of 90° C. or higher and 250° C. or lower, or a combination of these.

Crystalline resins with the above melting point ranges are preferred as they are less prone to discoloration or degradation when overheated during laser marking.

Amorphous resins with the above glass transition temperature ranges are preferred as they are less prone to foaming when overheated during laser marking, thereby contributing to the reduction in the height of the protrusion and surface roughness. This results in a clearer black color of the titanium oxide discoloration layer on the printed portion, enhancing the contrast with the surrounding portion. Furthermore, by reducing the surface roughness, light scattering at the surface is reduced, which also contributes to the improved contrast between the printed portion and the surrounding portion.

As used herein, the melting point of crystalline resins refers to the peak temperature of the endothermic peak observed using a differential scanning calorimeter (DSC) when heated from 23° C. at a heating rate of 10° C./min. If two or more endothermic peaks are observed, the peak temperature of the highest temperature peak is taken as the melting point. The enthalpy of the endothermic peak observed at this time is preferably 10 J/g or more, and more preferably 20 J/g or more. Additionally, during measurement, it is preferable to heat the sample once to a temperature condition of 20° C. or higher above the melting point to melt the resin, then cool the sample to 23° C. at a cooling rate of 10° C./min before use.

Furthermore, as used herein, the glass transition temperature Tg of amorphous resins refers to the peak-top temperature of the peak (maximum point of tan δ, which is E2/E1)) at which the storage modulus (E1) significantly decreases and the loss modulus (E2) reaches the maximum when a measurement is performed at an applied frequency of 8 Hz using a dynamic mechanical analyzer while the resin is heated from 23° C. at a heating rate of 3° C./min. If two or more loss modulus peaks are observed, the peak temperature of the highest temperature peak is taken as the glass transition temperature. In this measurement, the frequency of measurement shall be at least once every 20 seconds to enhance accuracy. Furthermore, although there is no particular limitation on the preparation method of the measurement sample, it is preferable that a cutout piece from a thermally pressed molded article is used to eliminate the effect of molding strain. From the perspective of thermal conductivity, it is preferable that the dimensions (width and thickness) of the cutout piece be as small as possible.

The thermoplastic resin (A) may be a homopolymer or may be a copolymer.

One type of the above-described resin may be used, or two or more types may be used in combination as the thermoplastic resin (A). The thermoplastic resin (A) may also be a resin as described above, modified with at least one compound selected from unsaturated carboxylic acids, anhydrides thereof, and derivatives thereof.

From the perspective of heat resistance, moldability, designability, and mechanical properties, it is preferable that the thermoplastic resin (A) be one or more resins selected from polyolefin-based resins, polyamide-based resins, polyester-based resins, polyacetal-based resins, polyacrylic resins, polyphenylene-based ether resins, and polyphenylene sulfide-based resins.

The thermoplastic resin (A) more preferably contains a polyamide-based resin (A1) and/or a polyester-based resin (A2), is even more preferably only a polyamide-based resin (A1) and/or a polyester-based resin (A2), and is particularly preferably only a polyamide-based resin (A1). This enhances the clarity of the printed markings made by laser marking. The polyamide-based resin (A1) and/or polyester-based resin (A2) may be used alone or in combination with other thermoplastic resins.

The proportion of the total mass of a polyamide-based resin (A1) and/or polyester-based resin (A2) per 100 mass % of the thermoplastic resin (A) is preferably 10 to 100 mass %, more preferably 30 to 100 mass %, even more preferably 50 to 100 mass %, and still even more preferably 70 to 100 mass %. Increasing the proportion of these resins in the thermoplastic resin (A) improves the whiteness of the unprocessed portion, increases the color difference with the processed portion, and enhances the clarity of the printed markings.

When both a polyamide-based resin (A1) and a polyester-based resin (A2) are contained, the mass ratio of the polyester-based resin (A2) to 100 mass % of the total amount of the polyamide-based resin (A1) and the polyester-based resin (A2) is preferably 5 to 50 mass %, more preferably 5 to 30 mass %. The above numerical range increases heat resistance, making discoloration or degradation less likely to occur when the processed area is overheated during laser marking.

The mass ratio of the thermoplastic resin (A) per 100 mass % of the resin composition is preferably 20 mass % or more, more preferably 30 mass % or more, even more preferably 40 mass % or more, and particularly preferably 50 mass % or more.

### (Polyamide-Based Resin (A1))

The polyamide-based resin (A1) is preferably a semi-aromatic polyamide (A1-2) having an aromatic ring in the backbone thereof or an alloy of an aliphatic polyamide (A1-1) and the semi-aromatic polyamide (A1-2). This enhances the clarity of the printed markings made by laser marking. Note that when the polyamide-based resin (A1) is an alloy, the thermoplastic resin (A) may be a ternary or more alloy further combined with another thermoplastic resin.

When the polyamide-based resin (A1) is an alloy as described above, the respective contents of the aliphatic polyamide (A1-1) and the semi-aromatic polyamide (A1-2) in the polyamide-based resin (A1) are not particularly limited.

Particularly, the content of semi-aromatic polyamide (A1-2) is preferably 5.0 parts by mass or more and 100.0 parts by mass or less, more preferably 5.0 parts by mass or more and 95.0 parts by mass or less, even more preferably 10.0 parts by mass or more and 80.0 parts by mass or less, and still even more preferably 15.0 parts by mass or more and 70.0 parts by mass or less, per 100.0 parts by mass of the total amount of the aliphatic polyamide (A1-1) and the semi-aromatic polyamide (A1-2).

Furthermore, the content of the aliphatic polyamide (A1-1) is preferably more than 0.0 to 95.0 parts by mass or less, more preferably 5.0 parts by mass or more and 95.0 parts by mass or less, even more preferably 7.0 parts by mass or more and 80.0 parts by mass or less, and still even more preferably 9.0 parts by mass or more and 70.0 parts by mass or less, per 100.0 parts by mass of the total amount of the aliphatic polyamide (A1-1) and the semi-aromatic polyamide (A1-2).

Maintaining the respective contents of the aliphatic polyamide (A1-1) and the semi-aromatic polyamide (A1-2) within the above numerical ranges further enhances the clarity of the printed markings made by laser marking.

The total mass of the aliphatic polyamide (A1-1) and the semi-aromatic polyamide (A1-2) per 100 mass % of the polyamide-based resin (A1) is preferably 80 mass % or more, more preferably 90 mass % or more, and even more preferably 100 mass %.

### (1) Aliphatic Polyamide (A1-1)

The constituent units of the aliphatic polyamide (A1-1) preferably satisfy at least one of the following conditions (1) and (2):
(1) An aliphatic dicarboxylic acid unit (A1-1a) and an aliphatic diamine unit (A1-1b) are contained; and
(2) At least one constituent unit (A1-1c) selected from the group consisting of lactam units and aminocarboxylic acid units is contained.

The constituent units of the aliphatic polyamide (A1-1) may contain one or more constituent units that satisfy at least one of the above conditions (1) and (2). In particular, it is preferable that the constituent units of the aliphatic polyamide (A1-1) satisfy the condition (1).

### (1-1) Aliphatic Dicarboxylic Acid Unit (A1-1a)

Examples of the aliphatic dicarboxylic acid constituting the aliphatic dicarboxylic acid unit (A1-1a) include straight-chain or branched-chain saturated aliphatic dicarboxylic acids with 3 or more and 20 or fewer carbon atoms.

Examples of straight-chain saturated aliphatic dicarboxylic acids with 3 or more and 20 or fewer carbon atoms include the following, but are not limited to, malonic acid, succinic acid, glutaric acid, adipic acid, pimelic acid, suberic acid, azelaic acid, sebacic acid, dodecanedioic acid, tetradecanedioic acid, hexadecanedioic acid, octadecanedioic acid, eicosanedioic acid, and diglycolic acid.

Examples of branched-chain saturated aliphatic dicarboxylic acids with 3 or more and 20 or fewer carbon atoms include the following, but are not limited to, dimethylmalonic acid, 2,2-dimethylsuccinic acid, 2,3-dimethylglutaric acid, 2,2-diethylsuccinic acid, 2,3-diethylglutaric acid, 2,2-dimethylglutaric acid, 2-methyladipic acid, and trimethyladipic acid.

One of these aliphatic dicarboxylic acids constituting these aliphatic dicarboxylic acid units (A1-1a) may be used alone, or two or more of these may be used in combination.

Among these, from the perspective of achieving more excellent heat resistance, fluidity, toughness, low water absorption, and rigidity of the resin composition, a straight-chain saturated aliphatic dicarboxylic acid with 6 or more carbon atoms is preferable as the aliphatic dicarboxylic acid constituting the aliphatic dicarboxylic acid unit (A1-1a).

Specific examples of preferred straight-chain saturated aliphatic dicarboxylic acids with 6 or more carbon atoms include adipic acid, sebacic acid, dodecanedioic acid, tetradecanedioic acid, hexadecanedioic acid, octadecanedioic acid, and eicosanedioic acid.

Among these, from the perspective of heat resistance of the resin composition, adipic acid, sebacic acid, or dodecanedioic acid is preferable.

The aliphatic polyamide (A1-1) may further contain units derived from trivalent or higher polycarboxylic acids as needed, as long as the effects of the molded article of the present embodiment are not impaired. Examples of trivalent or higher polycarboxylic acids include trimellitic acid, trimesic acid, and pyromellitic acid. One of these trivalent or higher polyvalent carboxylic acids may be used alone, or two or more of these may be used in combination.

### (1-2) Aliphatic Diamine Unit (A1-1b)

Examples of the aliphatic diamine constituting the aliphatic diamine unit (A1-1b) include straight-chain saturated aliphatic diamines with 2 or more and 20 or fewer carbon atoms or branched-chain saturated aliphatic diamines with 3 or more and 20 or fewer carbon atoms.

Examples of straight-chain saturated aliphatic diamines with 2 or more and 20 or fewer carbon atoms include the following, but are not limited to, ethylenediamine, propylenediamine, tetramethylenediamine, pentamethylenediamine, hexamethylenediamine, heptamethylenediamine, octamethylenediamine, nonamethylenediamine, decamethylenediamine, undecamethylenediamine, dodecamethylenediamine, and tridecamethylenediamine.

Examples of branched-chain saturated aliphatic diamines with 3 or more and 20 or fewer carbon atoms include the following, but are not limited to, 2-methylpentamethylenediamine (also referred to as 2-methyl-1,5-diaminopentane), 2,2,4-trimethylhexamethylenediamine, 2,4,4-trimethylhexamethylenediamine, 2-methyl-1,8-octanediamine (also referred to as 2-methyloctamethylenediamine), and 2,4-dimethyloctamethylenediamine.

One of these aliphatic diamines constituting these aliphatic diamine units (A1-1b) may be used alone, or two or more of these may be used in combination.

Among these, the carbon number of the aliphatic diamine constituting the aliphatic diamine unit (A1-1b) is preferably 6 or more and 12 or less, and more preferably 6 or more and 10 or less. Having a carbon number within the above-described lower limit or more further enhances the heat resistance of the molded article. On the other hand, when the carbon number is the above-described upper limit or less, the crystallinity and mold release properties of the molded article are improved.

Specific examples of preferred straight-chain or branched-chain saturated aliphatic diamines with 6 or more and 12 or fewer carbon atoms include hexamethylenediamine, 2-methylpentamethylenediamine, and 2-methyl-1,8-octanediamine.

Among these, hexamethylenediamine or 2-methylpentamethylenediamine is preferable as a straight-chain or branched-chain saturated aliphatic diamine with 6 or more and 12 or fewer carbon atoms. By including such an aliphatic diamine unit (A1-1b), the heat resistance and rigidity of the molded article are further improved.

Furthermore, the aliphatic polyamide (A1-1) may optionally contain units derived from a trivalent or higher polyvalent aliphatic amine, as long as the effects of the molded article of the present embodiment are not impaired. An example of such a trivalent or higher polyvalent aliphatic amine is bishexamethylenetriamine.

(1-3) At Least One Structural Unit (A1-1c) Selected from the Group Consisting of Lactam Units and Aminocarboxylic Acid Units

The aliphatic polyamide (A1-1) may contain at least one structural unit (A1-1c) selected from the group consisting of lactam units and aminocarboxylic acid units. The inclusion of such units tends to produce polyamides with excellent toughness.

As used herein, the term “lactam unit” and “aminocarboxylic acid unit” refer to the polymerized (condensed) forms of lactams and aminocarboxylic acids, respectively.

Examples of the lactams constituting the lactam units include the following, but are not limited to, for example, butyrolactam, pivalolactam, ε-caprolactam, caprylolactam, enantholactam, undecanolactam, and laurolactam (dodecanolactam).

Among these, preferred lactams constituting the lactam unit include ε-caprolactam and laurolactam, with ε-caprolactam being more preferable. By including such lactams, the toughness of the molded article tends to be improved.

Examples of the aminocarboxylic acid constituting aminocarboxylic acid units include the following, but are not limited to, for example, ω-aminocarboxylic acids and α,ω-amino acids, which are formed by the ring opening of lactams.

Additionally, as the aminocarboxylic acid constituting aminocarboxylic acid units, straight-chain or branched-chain saturated aliphatic carboxylic acids with 4 or more and 14 or fewer carbon atoms substituted with an amino group at the ω-position are preferred. Examples of such aminocarboxylic acids include the following, but are not limited to, 6-aminocaproic acid, 11-aminoundecanoic acid, and 12-aminododecanoic acid, for example. Additionally, para-aminomethylbenzoic acid is also exemplified as the aminocarboxylic acid.

One type of these lactams and aminocarboxylic acids constituting the structural unit (A1-1c) may be used, or two or more of these may be used in combination.

The weight-average molecular weight can be used as an indicator for the molecular weight of the aliphatic polyamide (A1-1). The weight-average molecular weight of the aliphatic polyamide is preferably 10,000 or more and 50,000 or less, more preferably 17,000 or more and 45,000 or less, even more preferably 20,000 or more and 45,000 or less, still even more preferably 25,000 or more and 45,000 or less, particularly preferably 30,000 or more and 45,000 or less, and most preferably 35,000 or more and 40,000 or less.

When the weight-average molecular weight is within the specified range, a molded article with clearer printed markings made by laser marking can be obtained.

The weight-average molecular weight of the aliphatic polyamide (A1-1) can be measured, for example, using gel permeation chromatography (GPC).

### (2) Semi-Aromatic Polyamide (A1-2)

The semi-aromatic polyamide (A1-2) is a polyamide having an aromatic ring in the backbone thereof and contains diamine units and dicarboxylic acid units.

The semi-aromatic polyamide (A1-2) preferably contains 10 mol % or more and 95 mol % or less of aromatic constituent units, more preferably contains 20 mol % or more and 90 mol % or less of aromatic constituent units, even more preferably contains 30 mol % or more and 85 mol % or less of aromatic constituent units, with respect to the total constituent units of the semi-aromatic polyamide (A1-2). As used herein, the term “aromatic constituent units” refers to an aromatic diamine unit and an aromatic dicarboxylic acid unit.

The semi-aromatic polyamide (A1-2) contains preferably 10 mol % or more of aromatic dicarboxylic acid units (preferably isophthalic acid units), more preferably 30 mol % or more, even more preferably 50 mol % or more of aromatic dicarboxylic acid units (preferably isophthalic acid units), still even more preferably 75 mol % or more of aromatic dicarboxylic acid units (preferably isophthalic acid units), and particularly preferably 100 mol % of aromatic dicarboxylic acid units (preferably isophthalic acid units). per 100 mol % of the sum of all constituting dicarboxylic acid units contained in the semi-aromatic polyamide (A1-2).

When the content of aromatic dicarboxylic acid units is the above-described lower limit or more, the printed markings made by laser marking become clearer.

The aromatic dicarboxylic acid unit in the semi-aromatic polyamide (A1-2) is not particularly limited, but a terephthalic acid unit or an isophthalic acid unit is preferred, with the isophthalic acid unit being more preferred.

Note that the ratio of certain monomer units constituting the semi-aromatic polyamide (A1-2) can be measured by techniques such as nuclear magnetic resonance spectroscopy (1H-NMR).

Specifically, for example, the respective proportions of units derived from aromatic dicarboxylic acids, units derived from dicarboxylic acids other than aromatic dicarboxylic acids, units derived from aromatic diamines, and units derived from diamines other than aromatic diamines, constituting the semi-aromatic polyamide (A1-2) can be calculated by dissolving the semi-aromatic polyamide (A1-2) through heating in hexafluoroisopropanol at a concentration of approximately 5 mass %, performing 1H-NMR analysis using a nuclear magnetic resonance spectrometer (JNM-ECA-500) manufactured by JEOL Ltd, and calculating the integral ratios.

### (2-1) Dicarboxylic Acid Unit (A1-2a)

The dicarboxylic acid unit (A1-2a) constituting the semi-aromatic polyamide (A1-2) is not particularly limited, and examples include aromatic dicarboxylic acid units, aliphatic dicarboxylic acid units, and alicyclic dicarboxylic acid units.

### (2-1-1) Aromatic Dicarboxylic Acid Unit

Examples of the aromatic dicarboxylic acid constituting the aromatic dicarboxylic acid unit other than the isophthalic acid unit include the following, but are not limited to, dicarboxylic acids having a phenyl group or an aromatic group, such as a naphthyl group. The aromatic group of the aromatic dicarboxylic acid may be unsubstituted or may have a substituent.

Examples of the substituent include, but are not particularly limited to, for example, alkyl groups with 1 or more and 4 carbon atoms or less, aryl groups with 6 or more and 10 or fewer carbon atoms, arylalkyl groups with 7 or more and 10 or fewer carbon atoms, alkylaryl groups with 7 or more and 10 or fewer carbon atoms, halogen groups, silyl groups with 1 or more and 6 or fewer carbon atoms, and sulfonic acid groups and salts (such as sodium salt) thereof.

Examples of alkyl groups with 1 or more and 4 carbon atoms or less include the following, but are not limited to, methyl group, ethyl group, n-propyl group, isopropyl group, n-butyl group, isobutyl group, and tert-butyl group, for example.

Examples of aryl groups with 6 or more and 10 or fewer carbon atoms include the following, but are not limited to, phenyl groups and naphthyl groups.

Examples of arylalkyl groups with 7 or more and 10 or fewer carbon atoms include the following, but are not limited to, benzyl groups.

Examples of alkylaryl groups with 7 or more and 10 or fewer carbon atoms include the following, but are not limited to, tolyl groups and xylyl groups.

Examples of halogen groups include the following, but are not limited to, fluoro groups, chloro groups, bromo groups, and iodo groups.

Examples of silyl groups with 1 or more and 6 or fewer carbon atoms include the following, but are not limited to, trimethylsilyl groups and tert-butyldimethylsilyl groups.

Among these, aromatic dicarboxylic acids constituting the aromatic dicarboxylic acid unit other than isophthalic acid units are preferably aromatic dicarboxylic acids with 8 or more and 20 or fewer carbon atoms that are unsubstituted or substituted with specific substituents.

Specific examples of such aromatic dicarboxylic acids include the following, but are not limited to, terephthalic acid, naphthalenedicarboxylic acid, 2-chloroterephthalic acid, 2-methylterephthalic acid, 5-methylisophthalic acid, and 5-sodium sulfoisophthalic acid.

One aromatic dicarboxylic acid may be used alone, or two or more aromatic dicarboxylic acids may be used in combination, to constitute the aromatic dicarboxylic acid unit.

### (2-1-2) Aliphatic Dicarboxylic Acid Unit

Examples of aliphatic dicarboxylic acids constituting the aliphatic dicarboxylic acid unit include straight-chain or branched-chain saturated aliphatic dicarboxylic acids with 3 or more and 20 or fewer carbon atoms.

Specific examples of straight-chain saturated aliphatic dicarboxylic acids with 3 or more and 20 or fewer carbon atoms include the following, but are not limited to, malonic acid, succinic acid, glutaric acid, adipic acid, pimelic acid, suberic acid, azelaic acid, sebacic acid, dodecanedioic acid, tetradecanedioic acid, hexadecanedioic acid, octadecanedioic acid, eicosanedioic acid, and diglycolic acid.

Specific examples of branched-chain saturated aliphatic dicarboxylic acids with 3 or more and 20 or fewer carbon atoms include the following, but are not limited to, dimethylmalonic acid, 2,2-dimethylsuccinic acid, 2,3-dimethylglutaric acid, 2,2-diethylsuccinic acid, 2,3-diethylglutaric acid, 2,2-dimethylglutaric acid, 2-methyladipic acid, and trimethyladipic acid.

### (2-1-3) Alicyclic Dicarboxylic Acid Unit

Alicyclic dicarboxylic acids constituting the alicyclic dicarboxylic acid unit (hereinafter sometimes referred to as “alicyclic dicarboxylic acid unit”) include the following, but are not limited to, alicyclic dicarboxylic acids having an alicyclic structure with 3 or more and 10 or less acarbon atoms. Among these, alicyclic dicarboxylic acids having an alicyclic structure with 5 or more and 10 or fewer carbon atoms are preferred.

Examples of such alicyclic dicarboxylic acid include the following, but are not limited to, for example, 1,4-cyclohexane dicarboxylic acid, 1,3-cyclohexane dicarboxylic acid, and 1,3-cyclopentane dicarboxylic acid. Among these, 1,4-cyclohexanedicarboxylic acid is preferable as the alicyclic dicarboxylic acid.

One alicyclic dicarboxylic acid may be used alone, or two or more alicyclic dicarboxylic acids may be used in combination, to constitute the alicyclic dicarboxylic acid unit.

The alicyclic group in the alicyclic dicarboxylic acid may be unsubstituted or may have a substituent. As substituents, an alkyl group with 1 or more and 4 or fewer carbon atoms is exemplified. As the alkyl group with 1 or more and 4 or fewer carbon atoms, those exemplified in the “aromatic dicarboxylic acid units” mentioned above can be cited.

The dicarboxylic acid unit other than the isophthalic acid unit preferably contains an aromatic dicarboxylic acid unit, and more preferably an aromatic dicarboxylic acid with 6 or more and 12 or fewer carbon atoms.

By using such dicarboxylic acids, a resin composition with more excellent mechanical properties tends to be obtained. Additionally, a molded article with clearer printed markings made by laser marking can be obtained.

In the semi-aromatic polyamide (A1-2), the dicarboxylic acid constituting the dicarboxylic acid unit (A1-2a) is not limited to the compounds listed as dicarboxylic acids above, but may be any compound equivalent to the above dicarboxylic acids.

As used herein, the term “compound equivalent to dicarboxylic acid” as used herein refers to a compound that can be a dicarboxylic acid structure similar to the dicarboxylic acid structure derived from the above dicarboxylic acid. Such compounds include the following, but are not limited to, anhydrides of dicarboxylic acids and halides of dicarboxylic acids, for example.

In addition, the semi-aromatic polyamide (A1-2) may further contain units derived from trivalent or higher polyvalent carboxylic acids, as needed, without impairing the effects exhibited by the molded article of the present embodiment.

Examples of trivalent or higher polyvalent carboxylic acids include trimellitic acid, trimesic acid, and pyromellitic acid. One of these trivalent or higher polyvalent carboxylic acids may be used alone, or two or more of these may be used in combination.

### (2-2) Diamine Unit (A1-2b)

The diamine unit (A1-2b) constituting the semi-aromatic polyamide (A1-2) is not particularly limited, and examples include aromatic diamine units, aliphatic diamine units, and alicyclic diamine units. Among these, the semi-aromatic polyamide (A1-2) preferably contains a diamine unit (A1-2b) with 4 or more and 10 or fewer carbon atoms, and more preferably contains a diamine unit with 6 or more and 10 or fewer carbon atoms.

### (2-2-1) Aliphatic Diamine Unit

Examples of aliphatic diamines constituting the aliphatic diamine unit include straight-chain saturated aliphatic diamines with 4 or more and 20 or fewer carbon atoms.

Examples of straight-chain saturated aliphatic diamines with 4 or more and 20 or fewer carbon atoms include the following, but are not limited to, ethylenediamine, propylenediamine, tetramethylenediamine, pentamethylenediamine, hexamethylenediamine, heptamethylenediamine, octamethylenediamine, nonamethylenediamine, decamethylenediamine, undecamethylenediamine, dodecamethylenediamine, and tridecamethylenediamine.

### (2-2-2) Alicyclic Diamine Units

Examples of the alicyclic diamine constituting the alicyclic diamine unit (hereinafter, may also be referred to as “alicyclic-type diamine”) include the following, but are not limited to, 1,4-cyclohexane diamine, 1,3-cyclohexane diamine, and 1,3-cyclopentane diamine, for example.

### (2-2-3) Aromatic Diamine Units

The aromatic diamine units are not limited to the following, as long as they are aromatic diamines containing an aromatic group. Specific examples of aromatic diamines include, for example, m-xylylenediamine.

One diamine may be used alone, or two or more diamines may be used in combination, to constitute each diamine unit.

Among these, as the diamine units (A1-2b), aliphatic diamine units are preferable, straight-chain saturated aliphatic diamine units with 4 or more and 10 or fewer carbon atoms are more preferable, straight-chain saturated aliphatic diamine units with 6 or more and 10 or fewer carbon atoms are further preferable, and hexamethylenediamine units are particularly preferable.

By using such diamines, a resin composition with more excellent mechanical properties tends to be obtained. Additionally, a molded article with clearer printed markings made by laser marking can be obtained.

The weight-average molecular weight can be used as an indicator for the molecular weight of the semi-aromatic polyamide (A1-2). The weight-average molecular weight of the semi-aromatic polyamide is preferably 10,000 or more and 50,000 or less, more preferably 15,000 or more and 45,000 or less, further preferably 15,000 or more and 40,000 or less, even further preferably 17,000 or more and 35,000 or less, particularly preferably 17,000 or more and 30,000 or less, and most preferably 18,000 or more and 28,000 or less.

When the weight-average molecular weight is within the specified range, a molded article with clearer printed markings made by laser marking can be obtained.

The weight-average molecular weight of the semi-aromatic polyamide (A1-2) can be measured using, for example, GPC.

### (3) End-Capping Agent

The ends of the polyamide-based resin (A1) may be capped with a known end-capping agent.

Such an end-capping agent can be added as a molecular weight regulator when a polyamide is manufactured from the dicarboxylic acids and diamines described above, or from at least one selected from the group consisting of the lactams and aminocarboxylic acids described above.

Examples of the end-capping agent include the following, but are not limited to, monocarboxylic acids, monoamines, acid anhydrides (such as phthalic anhydride), monoisocyanates, monoesters, and mono alcohols, for example. One end-capping agent may be used alone, or two or more end-capping agents may be used in combination.

Among these, monocarboxylic acids or monoamines are preferable as the end-capping agent. By capping the ends of the polyamide with the end-capping agent, the molded article tends to exhibit more excellent thermal stability.

The monocarboxylic acids that can be used as end-capping agents are not particularly limited as long as they have reactivity with the amino groups that may be present at the ends of the polyamide. Examples of monocarboxylic acids include the following, but are not limited to, for example, aliphatic monocarboxylic acids, alicyclic monocarboxylic acids, and aromatic monocarboxylic acids.

Examples of aliphatic monocarboxylic acids include formic acid, acetic acid, propionic acid, butyric acid, valeric acid, caproic acid, caprylic acid, lauric acid, tridecanoic acid, myristic acid, palmitic acid, stearic acid, pivalic acid, and isobutyric acid.

Examples of alicyclic monocarboxylic acids include cyclohexanecarboxylic acid.

Examples of aromatic monocarboxylic acids include benzoic acid, toluic acid, α-naphthoic acid, β-naphthoic acid, methylnaphthoic acid, and phenylacetic acid.

One of these monocarboxylic acids may be used alone, or two or more of these may be used in combination.

In particular, the ends of the semi-aromatic polyamide (A1-2) are preferably capped by acetic acid in view of flowability and mechanical strength.

The monoamines that can be used as end-capping agents are not particularly limited as long as they have reactivity with the carboxyl groups that may be present at the ends of the polyamide. Examples of the monoamines include the following, but are not limited to, for example, aliphatic monoamines, alicyclic monoamines, and aromatic monoamines.

Examples of aliphatic monoamines include methylamine, ethylamine, propylamine, butylamine, hexylamine, octylamine, decylamine, stearylamine, dimethylamine, diethylamine, dipropylamine, and dibutylamine.

Examples of alicyclic monoamines include cyclohexylamine and dicyclohexylamine.

Examples of aromatic monoamines include aniline, toluidine, diphenylamine, and naphthylamine.

One of these monoamines may be used alone, or two or more of these may be used in combination.

A resin composition containing a polyamide capped with an end-capping agent tends to exhibit more excellent heat resistance, fluidity, toughness, low water absorption, and rigidity.

### (4) Preferred Polyamide-Based Resins (A1)

Preferred polyamide-based resins (A1) are not particularly limited, but examples include polyamides obtained by polycondensation reactions of lactams such as polyamide 6, polyamide 11, and polyamide 12; and polyamides obtained as copolymers from diamines and dicarboxylic acids, such as polyamide 66, polyamide 610, polyamide 611, polyamide 612, polyamide 66/6I, polyamide 4T, polyamide 6T, polyamide 6I, polyamide 6I/6T, polyamide 9T, polyamide 10T, polyamide 2M5T, polyamide MXD6, polyamide 6C, and polyamide 2M5C.

Among these, one or more aliphatic polyamides selected from the group consisting of polyamide 6, polyamide 11, polyamide 12, polyamide 66, polyamide 610, polyamide 611, and polyamide 612, or one or more semi-aromatic polyamides selected from the group consisting of polyamide 66/6I, polyamide 6T, polyamide 6I, polyamide 6I/6T, polyamide 9T, and polyamide MXD6 are more preferable.

### (Production Method of Polyamide-Based Resin (A1))

When the polyamide-based resin (A1) (aliphatic polyamide (A1-1) and semi-aromatic polyamide (A1-2)) is produced, it is preferable that the addition amounts of the dicarboxylic acid and the diamine are approximately equimolar. Considering the escape of the diamine from the reaction system during the polymerization reaction, it is preferable that the molar ratio of the total molar amount of the diamine relative to the total molar amount of the dicarboxylic acid is 0.9 or more and 1.2 or less, more preferably 0.95 or more and 1.1 or less, and even more preferably 0.98 or more and 1.05 or less.

The production method for the polyamide includes, but is not limited to, a polymerization step according to one of the following methods (1) or (2).
(1) The step of polymerizing a combination of the dicarboxylic acid constituting the dicarboxylic acid unit and the diamine constituting the diamine unit to obtain a polymer.
(2) The step of polymerizing one or more selected from the group consisting of a lactam constituting the lactam unit and an aminocarboxylic acid constituting the aminocarboxylic acid unit to obtain a polymer.

In addition, it is preferable that the method of producing the polyamide further includes, after the polymerization step, an increasing step of increasing the degree of polymerization of the polyamide. If necessary, the polymerization step and the increasing step may be followed by a capping step in which the ends of the resulting polymer are capped with an end-capping agent.

Specific examples of methods of producing the polyamide include various methods, for example, as exemplified in 1) to 4) below.
1) A method in which an aqueous solution or aqueous suspension of one or more selected from the group consisting of a dicarboxylic acid-diamine salt, a mixture of a dicarboxylic acid and a diamine, a lactam, and an aminocarboxylic acid is polymerized by heating while maintaining the molten state (hereinafter sometimes referred to as “thermal melt polymerization method”).
2) A method in which a polyamide obtained through the thermal melt polymerization method is maintained in the solid state at a temperature equal to or lower than the melting point to increase the degree of polymerization (hereinafter sometimes referred to as “thermal melt polymerization-solid phase polymerization method”).
3) A method in which one or more selected from the group consisting of a dicarboxylic acid-diamine salt, a mixture of a dicarboxylic acid and a diamine, a lactam, and an aminocarboxylic acid is polymerized while maintaining a solid state (hereinafter referred to as “solid phase polymerization method”).
4) A method in which a dicarboxylic acid halide component equivalent to a dicarboxylic acid and a diamine component are used for polymerization (hereinafter sometimes referred to as the “solution method”).

Among these, a production method including the thermal melt polymerization method is preferred as the specific method of producing the polyamide. When the polyamide is produced by the thermal melt polymerization method, it is preferable to maintain the molten state until polymerization is completed. In order to maintain the molten state, it is necessary to produce the polyamide composition under polymerization conditions suitable for the polyamide composition. The polymerization conditions include, for example, the following conditions. First, heating is continued while the polymerization pressure in the thermal melt polymerization method is controlled to 14 kg/cm² or more and 25 kg/cm² or less (gauge pressure). The pressure in the tank is then lowered over at least 30 minutes until reaching atmospheric pressure (gauge pressure is 0 kg/cm²).

In the method of producing the polyamide, the form of polymerization is not particularly limited and can be a batch or continuous method.

The polymerization apparatus used for the production of the polyamide is not particularly limited, and any known apparatus may be used. Specific examples of the polymerization apparatus include autoclave-type reactors, tumbler-type reactors, and extruder-type reactors (such as kneaders).

Hereinafter, a specific method of producing the polyamide by a batch-type thermal melt polymerization method will be described, but the production method of polyamide is not limited to this.

First, an aqueous solution containing approximately 40 mass % or more and 60 mass % or less of the raw material components for the polyamide (at least one selected from the group consisting of a combination of dicarboxylic acid and diamine, and optionally lactams and aminocarboxylic acids) is prepared. The aqueous solution is then concentrated in a concentration tank operated at a temperature of 110° C. or higher and 180° C. or lower and a pressure of about 0.035 MPa or more and 0.6 MPa or less (gauge pressure) to obtain a concentrated solution of about 65 mass % or more and 90 mass % or less.

The resulting concentrated solution is then transferred to an autoclave, and heating is continued until the pressure in the autoclave reaches about 1.2 MPa or more and 2.2 MPa or less (gauge pressure).

Then, the pressure is maintained at about 1.2 MPa or more and 2.2 MPa or less (gauge pressure) in the autoclave while removing at least one of the water and gas components. When the temperature reaches about 220° C. or more and 260° C. or less, the pressure is lowered to atmospheric pressure (gauge pressure is 0 MPa). After the pressure in the autoclave is reduced to atmospheric pressure, the by-produced water can be effectively removed by depressurizing the autoclave if necessary.

The autoclave is then pressurized with an inert gas such as nitrogen to extrude the polyamide melt from the autoclave as strands. The extruded strands are cooled and cut to obtain pellets of the polyamide.

The polyester-based resin (A2) is a polyester obtained by polycondensation of a dicarboxylic acid compound and a dihydroxy compound, polycondensation of an oxycarboxylic acid compound, polycondensation of these compounds, or the like, and may be either a homopolyester or a copolyester.

One type of polyester-based resin (A2) may be used alone or as an alloy of multiple resins.

As the dicarboxylic acid compound constituting the polyester-based resin (A2), aromatic dicarboxylic acids or ester-forming derivatives thereof are preferably used.

Examples of aromatic dicarboxylic acids include terephthalic acid, isophthalic acid, orthophthalic acid, 1,5-naphthalenedicarboxylic acid, 2,5-naphthalenedicarboxylic acid, 2,6-naphthalenedicarboxylic acid, biphenyl-2,2′-dicarboxylic acid, biphenyl-3,3′-dicarboxylic acid, biphenyl-4,4′-dicarboxylic acid, diphenyl ether-4,4′-dicarboxylic acid, diphenylmethane-4,4′-dicarboxylic acid, diphenylsulfone-4,4′-dicarboxylic acid, diphenylisopropylidene-4,4′-dicarboxylic acid, 1,2-bis(phenoxy) ethane-4,4′-dicarboxylic acid, anthracene-2,5-dicarboxylic acid, anthracene-2,6-dicarboxylic acid, p-terphenylene-4,4′-dicarboxylic acid, and pyridine-2,5-dicarboxylic acid, with terephthalic acid being particularly preferred.

Two of these aromatic dicarboxylic acids may be used in a mixture. As is well known, these can be used in polycondensation reactions not only in the free acid form thereof but also in the form of ester-forming derivatives such as dimethyl esters.

In addition, small amounts of aliphatic dicarboxylic acids such as adipic acid, azelaic acid, dodecanedioic acid, and sebacic acid, or alicyclic dicarboxylic acids such as 1,2-cyclohexanedicarboxylic acid, 1,3-cyclohexanedicarboxylic acid, and 1,4-cyclohexanedicarboxylic acid, may be used together with these aromatic dicarboxylic acids.

Examples of the dihydroxy compound constituting the polyester-based resin (A2) include aliphatic diols such as ethylene glycol, propylene glycol, butanediol, hexylene glycol, neopentyl glycol, 2-methylpropane-1,3-diol, diethylene glycol, and triethylene glycol, cyclic diols such as cyclohexane-1,4-dimethanol, and mixtures thereof. Additionally, small amounts of long-chain diols with a molecular weight of 400 to 6,000, such as polyethylene glycol, poly-1,3-propylene glycol, and polytetramethylene glycol, may be copolymerized.

Furthermore, aromatic diols such as hydroquinone, resorcinol, naphthalene diols, dihydroxydiphenyl ether, and 2,2-bis(4-hydroxyphenyl) propane may also be used.

In addition to bifunctional monomers as described above, small amounts of trifunctional monomers such as trimellitic acid, trimesic acid, pyromellitic acid, pentaerythritol, and trimethylolpropane may be used to introduce branched structures, and monofunctional compounds such as fatty acids may be used for molecular weight control.

Typically, the polyester-based resin (A2) is primarily derived from polycondensation of dicarboxylic acids and diols, with 50 mass % or more, preferably 70 mass % or more, of the total resin being derived from such polycondensates. Aromatic carboxylic acids are preferred as the dicarboxylic acids, and aliphatic diols are preferred as the diols.

Among these, particularly preferred are polyalkylene terephthalates in which 95 mol % or more of the acid component is terephthalic acid and 95 mass % or more of the alcohol component is an aliphatic diol. Representative examples include polybutylene terephthalate and polyethylene terephthalate. Preferably, those that are close to homopolyesters, meaning that 95 mass % or more of the entire resin consists of terephthalic acid components and 1,4-butanediol or ethylene glycol components, are preferred.

It is particularly preferable that the main component of the polyester-based resin (A2) is polybutylene terephthalate.

The intrinsic viscosity of the polyester-based resin (A2) is preferably from 0.5 to 2 dl/g. From the perspective of moldability and mechanical properties, a polyester-based resin with an intrinsic viscosity in the range of 0.6 to 1.5 dl/g is more preferable. When a polyester-based resin with an intrinsic viscosity lower than 0.5 dl/g is used, the resulting resin composition tends to have low mechanical strength. On the other hand, when the intrinsic viscosity exceeds 2 dl/g, the resin composition may exhibit poor fluidity, leading to reduced moldability. The intrinsic viscosity of the thermoplastic polyester resin is measured using a mixed solvent of tetrachloroethane and phenol in a ratio of 1:1 (mass ratio) at 30° C.

### [Titanium Oxide (B)]

The resin composition contains, as essential components, the above-described thermoplastic resin (A) and titanium dioxide (B) with an average particle size of 1 μm or less.

The average particle size of the titanium dioxide (B) is preferably 1 μm or less, more preferably 800 nm or less, even more preferably 500 nm or less, and still even more preferably 300 nm or less. The smaller the average particle size, the larger the surface area per unit volume, increasing the effects relative to the amount added. The average particle size may be 1 nm or more.

The method for measuring the average particle size of the titanium dioxide (B) is not particularly limited, but can be measured using dynamic light scattering or laser light scattering methods.

The amount of the titanium dioxide (B) added is preferably 0.5 parts by mass or more and 10 parts by mass or less, more preferably 0.6 parts by mass or more and 9.0 parts by mass or less, even more preferably 0.7 parts by mass or more and 8 parts by mass or less, still even more preferably 0.8 parts by mass or more and 7 parts by mass or less, and particularly preferably 0.9 parts by mass or more and 6 parts by mass or less, per 100 parts by mass of the thermoplastic resin (A). Excessive addition of the titanium dioxide (B) may reduce the toughness of the resin composition. Additionally, excessive titanium dioxide (B) near the surface may block the laser beam, reducing the proportion of the laser beam that penetrates the interior of the molded product, thereby reducing the clarity of printed markings using coloring agents that change color upon exposure to laser light. Conversely, if the addition amount of the titanium dioxide (B) is too low, there will be insufficient titanium dioxide to change color, resulting in reduced contrast in the printed portion.

The crystal form of the titanium dioxide (B) is not particularly limited, but the rutile type or anatase type is preferred, with the thermally stable rutile type being particularly preferable.

The surface treatment of the titanium dioxide (B) is not particularly limited, but the titanium dioxide (B) is preferably treated with substances such as alumina (Al₂O₃), silica (SiO₂), stearic acid, or alkyl silanes. Such a surface treatment can improve the dispersibility of the titanium dioxide (B) in the resin, enhance weather resistance, and impart excellent functions to the resin molded article.

The oil absorption amount of the titanium dioxide (B) is not particularly limited, but it is preferably 5 (g/100 g) or more, more preferably 10 (g/100 g) or more, even more preferably 15 (g/100 g) or more, and still even more preferably 20 (g/100 g) or more (oil used for the measurement: boiled linseed oil). A high oil absorption amount indicates a large surface area per unit volume, increasing the effects relative to the amount added.

### [Filler (C)]

The resin composition preferably further contains a filler (C) in addition to the thermoplastic resin (A) and the titanium dioxide (B). The inclusion of the filler (C) results in a resin composition with more excellent mechanical properties, such as strength and rigidity. The filler (C) refers to components other than the thermoplastic resin (A) and the titanium dioxide (B).

Examples of the filler (c) include, but are not particularly limited to, for example, glass fibers, carbon fibers, calcium silicate fibers, potassium titanate fibers, aluminum borate fibers, glass flakes, calcium carbonate, talc, kaolin, mica, hydrotalcite, zinc carbonate, calcium hydrogen phosphate, wollastonite, zeolite, boehmite, magnesium oxide, calcium silicate, sodium aluminosilicate, magnesium silicate, Ketjenblack, acetylene black, furnace black, carbon nanotubes, graphite, brass, copper, silver, aluminum, nickel, iron, calcium fluoride, montmorillonite, swellable fluorophlogopite, apatite, and milled fiber.

One type of these fillers (C) may be used alone, or two or more types of these may be used in combination.

Of these, in view of rigidity and strength, glass fibers, carbon fibers, glass flakes, talc, kaolin, mica, calcium hydrogen phosphate, wollastonite, carbon nanotubes, graphite, calcium fluoride, montmorillonite, expandable fluorine mica, or apatite are preferred as the filler (C). As the filler (C), one or more selected from the group consisting of glass fibers, calcium carbonate, talc, mica, wollastonite, and milled fiber are particularly preferable, with glass fibers or carbon fibers being more preferable, and glass fibers being particularly preferable.

When the filler (C) is glass fiber or carbon fiber, it is preferable that the number average fiber diameter (d1) thereof is 3 μm or more and 30 μm or less. Furthermore, the weight average fiber length (L) is preferably 100 μm or more and 5 mm or less. Furthermore, those with an aspect ratio ((L)/(d1)) of the number average fiber diameter (d1) to the weight average fiber length (L) of 3 or more and 100 or less are preferred. By using glass fibers or carbon fibers in the above structure, higher properties can be achieved.

Additionally, when the filler (C) is glass fiber, it is more preferable that the number average fiber diameter (d1) is 3 μm or more and 30 μm or less. It is more preferable that the weight average fiber length (L) is 103 μm or more and 5 mm or less. Furthermore, those with the aspect ratio ((L)/(d)) of 10 or more and 100 or less are more preferable.

The number average fiber diameter and weight average fiber length of the filler (C) can be measured using the following method.

First, a molded article is dissolved in a solvent such as formic acid, in which the thermoplastic resin (A) is soluble. Next, from the obtained insoluble components, for example, 100 or more fillers (C) are arbitrarily selected. Then, the filler (C) is observed with an optical microscope or a scanning electron microscope, and the number average fiber diameter can be determined by dividing the total measured fiber diameters by the number of measured fillers (C). Alternatively, the weight average fiber length can be determined by dividing the total measured fiber length by the total measured weight of the filler (C).

The resin composition contains preferably more than 0 parts by mass and 150.0 parts by mass or less of the filler (C), more preferably 10.0 parts by mass or more and 140.0 parts by mass or less of the filler (C), even more preferably 20.0 parts by mass or more and 135.0 parts by mass or less of the filler (C), particularly preferably 25.0 parts by mass or more and 130.0 parts by mass or less of the filler (C), and most preferably 30.0 parts by mass or more and 100.0 parts by mass or less of the filler (C), per 100 parts by mass of the thermoplastic resin (A).

When the content of the filler (C) is the above-described lower limit or more, the mechanical properties, such as strength and rigidity, of the molded article tend to be further improved. On the other hand, when the content of the filler (C) is the above-described upper limit or less, the molded article tends to exhibit more excellent surface appearance.

In particular, when the filler (C) is glass fiber and the content thereof is within the above range per 100 parts by mass of the thermoplastic resin (A), the mechanical properties such as strength and rigidity of the molded article tend to be even further improved.

### [Flame Retardant (D)]

It is preferable that the resin composition further contains a flame retardant (D) in addition to the thermoplastic resin (A) and the titanium oxide (B). The flame retardant (D) is a component other than the thermoplastic resin (A), the titanium oxide (B), and the filler (C).

There is no particular limitation on the flame retardant (D), and examples include phosphorus-based flame retardants that do not contain halogen elements.

One of these flame retardants (D) may be used alone, or two or more of these may be used in combination. Furthermore, flame retardancy can be further enhanced by using the flame retardant (D) in combination with a flame retardant auxiliary agent.

The phosphorus-based flame retardant is not particularly limited, and any flame retardant that does not contain halogen elements and contains phosphorus may be used. Examples of phosphorus-based flame retardants include phosphate ester-based flame retardants, melamine polyphosphate-based flame retardants, phosphazene-based flame retardants, phosphinic acid-based flame retardants, and red phosphorus-based flame retardants.

Among these, it is preferable that the flame retardant (D) is a phosphate ester-based flame retardant, a melamine polyphosphate-based flame retardant, a phosphazene-based flame retardant, or a phosphinic acid-based flame retardant, and it is particularly preferably a phosphinic acid-based flame retardant.

Specifically, examples of phosphinic acid-based flame retardants include phosphinate salts and diphosphinate salts. It is preferable that the flame retardant (D) is at least one selected from the group consisting of a phosphinate salt and a diphosphinate salt.

Examples of the phosphinate salt include a compound represented by the following formula (I) (hereinafter sometimes referred to as “phosphinate salt (I)”).

Examples of the diphosphinate salt include a diphosphinate salt represented by the following formula (II) (hereinafter referred to as “diphosphinate salt (II)”).

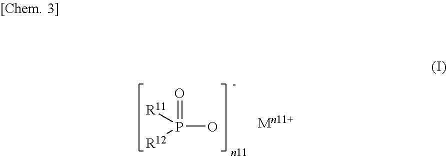

In the formula (I), R¹¹ and R¹² are each independently an alkyl group with 1 or more and 6 or fewer carbon atoms or an aryl group with 6 or more and 10 or fewer carbon atoms. Mⁿ¹¹⁺ is an n11-valent metal ion. M is an element belonging to Group 2 or Group 15 of the periodic table, a transition element, zinc, or aluminum. n11 is 2 or 3. The respective occurrences of R¹¹ and R¹² may each be identical or different.

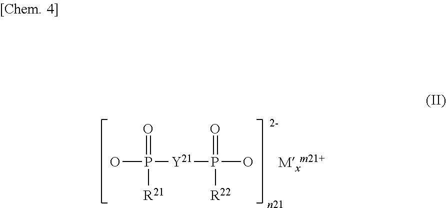

In the formula (II), R²¹ and R²² are each independently an alkyl group with 1 or more and 6 or fewer carbon atoms or an aryl group with 6 or more and 10 or fewer carbon atoms. Y²¹ is an alkylene group with 1 or more and 10 or fewer carbon atoms or an arylene group with 6 or more and 10 or fewer carbon atoms. M′ₓ^{m21+} is an m21-valent metal ion. M′ is an element belonging to Group 2 or Group 15 of the periodic table, a transition element, zinc, or aluminum. n21 is an integer of 1 or more and 3 or less. When n21 is 2 or 3, the respective occurrences of R²¹, R²², and Y²¹ may each be identical or different. m21 is 2 or 3. x is 1 or 2, When x is 2, occurrences of M′ may each be identical or different. n21, x, and m21 are integers that satisfy the relationship formula: 2×n21=m21×x.
(R¹¹, R¹², R²¹, and R²²)

R¹¹, R¹², R²¹, and R²² are each independently an alkyl group with 1 or more and 6 or fewer carbon atoms or an aryl group with 6 or more and 10 or fewer carbon atoms. The respective occurrences of R¹¹ and R¹² may each be identical or different; however, for ease of manufacturing, it is preferable that they are the same. In addition, when n21 is 2 or 3, the respective occurrences of R²¹ and R²² may each be identical or different; however, for ease of manufacturing, it is preferable that they are the same.

The alkyl group may be linear or cyclic, but it is preferably linear. The linear alkyl group may be either straight-chain or branched-chain. Examples of straight-chain alkyl groups include methyl, ethyl, n-propyl, n-butyl, n-pentyl, and n-hexyl groups. Examples of branched-chain alkyl groups include 1-methylethyl, 1-methylpropyl, 2-methylpropyl, 1,1-dimethylethyl, 1-methylbutyl, 2-methylbutyl, 3-methylbutyl, 1,1-dimethylpropyl, 1,2-dimethylpropyl, 2,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, and 1,1,2-trimethylpropyl groups.

Examples of aryl groups include phenyl and naphthyl groups.

The alkyl group and aryl group may have substituents. Examples of substituents on the alkyl group include aryl groups with 6 or more and 10 or fewer carbon atoms. Examples of substituents on the aryl group include alkyl groups with 1 or more and 6 or fewer carbon atoms.

Specific examples of alkyl groups with substituents include benzyl groups.

Specific examples of aryl groups with substituents include tolyl groups and xylyl groups.

Among these, R¹¹, R¹², R²¹, and R²² are preferably alkyl groups with 1 or more and 6 or fewer carbon atoms, with methyl or ethyl groups being more preferred.

### (Y²¹)

Y²¹ is an alkylene group with 1 or more and 10 or fewer carbon atoms or an arylene group with 6 or more and 10 or fewer carbon atoms. When n21 is 2 or 3, the occurrences of Y²¹ may each be identical or different; however, for ease of manufacturing, it is preferable that they are the same.

The alkylene group may be either linear or cyclic, but a linear alkylene group is preferred. The linear alkylene group may be straight-chain or branched-chain. Examples of straight-chain alkylene groups include methylene, ethylene, trimethylene, tetramethylene, pentamethylene, and hexamethylene groups. Examples of branched-chain alkylene groups include 1-methylethylene and 1-methylpropylene groups.

Examples of arylene groups include phenylene and naphthylene groups.

The alkylene and arylene groups may have substituents. Examples of substituents on the alkylene group include aryl groups with 6 or more and 10 or fewer carbon atoms. Examples of substituents on the arylene group include alkyl groups with 1 or more and 6 or fewer carbon atoms.

Specific examples of alkylene groups with substituents include phenylmethylene, phenylethylene, phenyltrimethylene, and phenyltetramethylene groups.

Specific examples of arylene groups with substituents include methylphenylene, ethylphenylene, tert-butylphenylene, methylnaphthylene, ethylnaphthylene, and tert-butylnaphthylene groups.

Among these, Y²¹ is preferably an alkylene group with 1 or more and 10 or fewer carbon atoms, with methylene or ethylene groups being more preferred.

### (M and M′)

M and M′ are each independently an ion of an element belonging to Group 2 or Group 15 of the periodic table, a transition metal ion, a zinc ion, or an aluminum ion. Examples of ions of elements belonging to Group 2 of the periodic table include calcium ions and magnesium ions. Examples of ions of elements belonging to Group 15 of the periodic table include bismuth ions.

When x is 2, the occurrences of M′ may each be identical or different; however, for ease of manufacturing, it is preferable that they are the same.

Among these, M and M′ are preferably calcium, zinc, or aluminum, with calcium or aluminum being more preferred.

(x)

x represents the number of M′ and is either 1 or 2. x can be appropriately selected according to the type of M′ and the number of diphosphinic acids.

(n11 and n21)

n11 represents the number of phosphinic acid groups and the valency of M, and is either 2 or 3. n11 can be appropriately selected according to the type and valency of M.

n21 represents the number of diphosphinic acid groups and is an integer of 1 or more and 3 or less. n21 can be appropriately selected depending on the type and valency of M′.

(m21)

m21 represents the valency of M′ and is either 2 or 3.

n21, x, and m21 are integers that satisfy the relationship formula: 2×n21=m21×x.

Specific examples of preferred phosphinate salts (I) include dimethylphosphinic acid calcium, dimethylphosphinic acid magnesium, dimethylphosphinic acid aluminum, dimethylphosphinic acid zinc, ethylmethylphosphinic acid calcium, ethylmethylphosphinic acid magnesium, ethylmethylphosphinic acid aluminum, ethylmethylphosphinic acid zinc, diethylphosphinic acid calcium, diethylphosphinic acid magnesium, diethylphosphinic acid aluminum, diethylphosphinic acid zinc, methyl-n-propylphosphinic acid calcium, methyl-n-propylphosphinic acid magnesium, methyl-n-propylphosphinic acid aluminum, methyl-n-propylphosphinic acid zinc, methylphenylphosphinic acid calcium, methylphenylphosphinic acid magnesium, methylphenylphosphinic acid aluminum, methylphenylphosphinic acid zinc, diphenylphosphinic acid calcium, diphenylphosphinic acid magnesium, diphenylphosphinic acid aluminum, and diphenylphosphinic acid zinc. Among these, phosphinate salts (I) are preferably dimethylphosphinic acid calcium, dimethylphosphinic acid aluminum, diethylphosphinic acid calcium, or diethylphosphinic acid aluminum, more preferably diethylphosphinic acid calcium or diethylphosphinic acid aluminum, and particularly preferably diethylphosphinic acid aluminum because of their excellent flame retardancy.

Specific examples of preferred diphosphinate salts (II) include methanedi(methylphosphinic acid) calcium, methanedi(methylphosphinic methanedi(methylphosphinic acid) aluminum, acid) magnesium, methanedi(methylphosphinic acid) zinc, benzene-1,4-di(methylphosphinic acid) calcium, benzene-1,4-di(methylphosphinic acid) magnesium, benzene-1,4-di(methylphosphinic acid) aluminum, and benzene-1,4-di(methylphosphinic acid) zinc.

The content of the flame retardant (D) is preferably 5.0 parts by mass or more and 90.0 parts by mass or less, more preferably 10.0 parts by mass or more and 80.0 parts by mass or less, even more preferably 15.0 parts by mass or more and 70.0 parts by mass or less, and particularly preferably 20.0 parts by mass or more and 60.0 parts by mass or less, per 100 parts by mass of the thermoplastic resin (A).

By setting the content of the flame retardant to the above-described lower limit or more, a resin composition with more excellent flame retardancy can be obtained. On the other hand, by setting the content of the flame retardant to the above-described upper limit or less, a resin composition with more excellent flame retardancy can be obtained without compromising the inherent properties of the resin composition.

### [Antimony-Based Oxides]

The resin composition is free of antimony-based oxides.

Examples of antimony-based oxides include antimony trioxide (Sb₂O₃), antimony tetroxide, antimony pentoxide, and sodium antimonate. It is preferable that the resin composition is free of compounds containing antimony elements. It is preferable that the thermoplastic resin (A), titanium oxide (B), filler (C), flame retardant (D), colorant (E), and other additives (F) are free of antimony elements.

### [Colorant (E)]

The resin composition may further contain a colorant (E) in addition to the thermoplastic resin (A) and the titanium oxide (B). The colorant (E) is a component other than the thermoplastic resin (A), the titanium oxide (B), the filler (C), and the flame retardant (D).

Commonly used colorants can be incorporated as the colorant (E), allowing the resin composition to be colored in any tone ranging from white to black and chromatic colors. Preferably, the resin composition can be colored white, light gray, gray, dark gray, or chromatic colors (such as orange). The colorant (E) may be a colorant that develops white, gray, or chromatic colors. The lightness (L*) of the colorant is preferably 25 or higher, more preferably 35 or higher, even more preferably 45 or higher, and still even more preferably 55 or higher. Additionally, the colorant (E) is preferably added so that the lightness (L*) of the molded article is 25 or higher, more preferably 35 or higher, even more preferably 45 or higher, and still even more preferably 55 or higher.

Lightness is measured using a spectrophotometer. More specifically, colorimetric measurement can be performed using a color meter SC-50μ manufactured by Suga Test Instruments Co., Ltd. with D65 light at 10°.

From the perspective of more excellent clarity of printed markings made by laser marking, a laser-absorbing colorant is preferred as the colorant (E).

Examples of such colorants include carbon black (such as acetylene black, lamp black, thermal black, furnace black, channel black, Ketjen black, gas black, oil black), graphite, titanium black, and black iron oxide. Among these, from the perspectives of dispersibility, color development, and cost, carbon black (E-1) is preferred. These colorants may be used alone or in combination of two or more.

Various inorganic and organic pigments mentioned below can be used as non-black pigments. These non-black pigments may be used alone or in combination of two or more.

Examples of inorganic pigments include white pigments such as calcium carbonate, zinc oxide, and zinc sulfide; yellow pigments such as cadmium yellow, lead yellow, titanium yellow, zinc chromate, ocher, and yellow iron oxide; red pigments such as red base pigments, amber, red iron oxide, and cadmium red; blue pigments such as Prussian blue, ultramarine, and cobalt blue; and green pigments such as chrome green.

Examples of organic pigments include azo-based, azomethine-based, methine-based, indanthrone-based, anthraquinone-based, pyranthrone-based, flavanthrone-based, benzanthrone-based, phthalocyanine-based, quinophthalone-based, perylene-based, perinone-based, dioxazine-based, thioindigo-based, isoindolinone-based, isoindoline-based, pyrrole-based, and quinacridone-based pigments.

The content of the colorant (E) is preferably 0.0001 parts by mass or more and 5.0000 parts by mass or less, more preferably 0.0005 parts by mass or more and 2.5000 parts by mass or less, and even more preferably 0.0010 parts by mass or more and 1.0000 parts by mass or less, per 100 parts by mass of the thermoplastic resin (A). When the content of the colorant (E) is the above-described lower limit or more, the heating efficiency by laser is further improved, and the clarity is further enhanced. On the other hand, when the content of the colorant (E) is the above-described upper limit or less, it is possible to more effectively prevent the degradation of properties and carbonization of the resin due to heating.

### [Other Additives (F)]

In addition to the thermoplastic resin (A) and the titanium oxide (B), the resin composition may further contain other additives (F) that are conventionally used in resin compositions, as long as the effects exhibited by the molded article of the present embodiment are not impaired. Examples of other additives (F) include moldability improving agents, degradation inhibitors, nucleating agents, and heat stabilizers.

The content of other additives (F) in the resin composition varies depending on the type and application of the composition, and there is no particular limitation as long as the effects exhibited by the molded article of the present embodiment are not impaired.

The other additives (F) are components other than the thermoplastic resin (A), the titanium oxide (B), the filler (C), the flame retardant (D), and the colorant (E).

### (Moldability Improving Agents)

The moldability improving agents are not particularly limited, and examples include higher fatty acids, metal salts of higher fatty acids, higher fatty acid esters, and higher fatty acid amides. It should be noted that moldability improving agents are also used as “lubricants.”

### (1) Higher Fatty Acids

Examples of higher fatty acids include straight-chain or branched-chain, saturated or unsaturated aliphatic monocarboxylic acids with 8 or more and 40 or fewer carbon atoms.

Examples of straight-chain saturated aliphatic monocarboxylic acids with 8 or more and 40 or fewer carbon atoms include lauric acid, palmitic acid, stearic acid, behenic acid, and montanic acid.

Examples of branched-chain saturated aliphatic monocarboxylic acids with 8 or more and 40 or fewer carbon atoms include isopalmitic acid and isostearic acid.

Examples of straight-chain unsaturated aliphatic monocarboxylic acids with 8 or more and 40 or fewer carbon atoms include oleic acid and erucic acid.

Examples of branched-chain unsaturated aliphatic monocarboxylic acids with 8 or more and 40 or fewer carbon atoms include isoleic acid.

Among these, stearic acid or montanic acid is preferred as a higher fatty acid.

### (2) Metal Salts of Higher Fatty Acids

Metal salts of higher fatty acids are metal salts of higher fatty acids.

Examples of metal elements in the metal salts include Group 1, Group 2, and Group 3 elements of the periodic table, as well as zinc and aluminum.

Examples of Group 1 elements of the periodic table include sodium and potassium.

Examples of Group 2 elements of the periodic table include calcium and magnesium.

Examples of Group 3 elements of the periodic table include scandium and yttrium.

Among these, Group 1 and Group 2 elements or aluminum are preferred, with sodium, potassium, calcium, magnesium, or aluminum being more preferred.

Specific examples of metal salts of higher fatty acids include calcium stearate, aluminum stearate, zinc stearate, magnesium stearate, calcium montanate, sodium montanate, and calcium palmitate.

Among these, metal salts of montanic acid or stearic acid are preferred.

### (3) Higher Fatty Acid Esters

A higher fatty acid ester is an esterification product of a higher fatty acid and an alcohol.

A preferred higher fatty acid ester is an ester of an aliphatic carboxylic acid with 8 or more and 40 or fewer carbon atoms and an aliphatic alcohol with 8 or more and 40 or fewer carbon atoms.

Examples of aliphatic alcohols with 8 or more and 40 or fewer carbon atoms include stearyl alcohol, behenyl alcohol, and lauryl alcohol.

Specific examples of higher fatty acid esters include stearyl stearate and behenyl behenate.

### (4) Higher Fatty Acid Amides

A higher fatty acid amide is an amide compound of a higher fatty acid.

Examples of higher fatty acid amides include stearamide, oleamide, erucamide, ethylene bis(stearamide), ethylene bis(oleamide), N-stearyl stearamide, and N-stearyl erucamide.

These higher fatty acids, higher fatty acid metal salts, higher fatty acid esters, and higher fatty acid amides can be used alone or in combination of two or more.

### (Degradation Inhibitors)

Degradation inhibitors are used to prevent thermal degradation, discoloration during heating, and to improve heat aging resistance.

Although degradation inhibitors are not particularly limited, examples include copper compounds, phenolic stabilizers, phosphite-based stabilizers, hindered amine-based stabilizers, triazine-based stabilizers, benzotriazole-based stabilizers, benzophenone-based stabilizers, cyanoacrylate-based stabilizers, salicylate-based stabilizers, and sulfur-based stabilizers.

Examples of copper compounds include copper acetate and copper iodide.

An example of a phenolic stabilizer is a hindered phenol compound.

One of these degradation inhibitors may be used alone, or two or more of these may be used in combination.

### (Nucleating Agents)

A nucleating agent refers to a substance that, when added, provides at least one of the following effects:
(1) the effect of increasing the crystallization peak temperature of the resin composition;
(2) the effect of reducing the difference between the extrapolated onset and extrapolated end temperatures of the crystallization peak; and
(3) the effect of refining or uniformizing the sizes of spherulites in the resulting molded article.

Examples of nucleating agents include the following, but are not limited to, talc, boron nitride, mica, kaolin, silicon nitride, carbon black, potassium titanate, and molybdenum disulfide.

One nucleating agent may be used alone, or two or more nucleating agents may be used in combination.

Among these, from the perspective of the effects of nucleating agents, talc or boron nitride is preferred.

For achieving better effects of nucleating agents, the number-average particle size of the nucleating agents is preferably 0.01 μm or more and 10 μm or less.

The number-average particle size of a nucleating agent can be measured using the following method. First, a molded article is dissolved in a solvent such as formic acid, which dissolves the resin composition. Next, from the obtained insoluble components, 100 or more nucleating agent particles are randomly selected. The particle sizes of the nucleating agent particles are then measured using an optical microscope or a scanning electron microscope.

The content of the nucleating agent in the resin composition is preferably 0.001 parts by mass or more and 1 part by mass or less, more preferably 0.001 parts by mass or more and 0.5 parts by mass or less, and even more preferably 0.001 parts by mass or more and 0.09 parts by mass or less, per 100 parts by mass of the thermoplastic resin (A).

When the content of the nucleating agent is the above-described lower limit or more, the heat resistance of the molded article tends to be improved. On the other hand, when the content is the above-described upper limit or less, a molded article with more excellent toughness can be obtained.

### (Heat Stabilizer)

Although the heat stabilizer is not particularly limited, examples include phenolic heat stabilizers, phosphorus-based heat stabilizers, amine-based heat stabilizers, and metal salts of elements of Groups 3, 4, and 11 to 14 of the periodic table.

### (1) Phenolic Heat Stabilizers

Examples of phenolic heat stabilizers include the following, but are not limited to, hindered phenol compounds. Hindered phenol compounds have properties that impart excellent heat resistance and light resistance to resins such as polyamide and fibers.

Examples of hindered phenol compounds include the following, but are not limited to, N,N′-hexane-1,6-diylbis[3-(3,5-di-tert-butyl-4-hydroxyphenyl)propionamide], pentaerythritol tetrakis[3-(3,5-di-tert-butyl-4-hydroxyphenyl)propionate], N,N′-hexamethylenebis(3,5-di-tert-butyl-4-hydroxyhydrocinnamamide), triethylene glycol bis[3-(3-tert-butyl-5-methyl-4-hydroxyphenyl)propionate], 3,9-bis {2-[3-(3-tert-butyl-4-hydroxy-5-methylphenyl) propionyloxy]-1,1-dimethylethyl}-2,4,8,10-tetraoxaspiro[5.5]undecane, 3,5-di-tert-butyl-4-hydroxybenzylphosphonate diethyl ester, 1,3,5-trimethyl-2,4,6-tris(3,5-di-tert-butyl-4-hydroxybenzyl)benzene, and 1,3,5-tris(4-tert-butyl-3-hydroxy-2,6-dimethylbenzyl)isocyanurate, for example.

One of these hindered phenol compounds may be used alone, or two or more of these may be used in combination.

When a phenolic heat stabilizer is used, the content of the phenolic heat stabilizer in the resin composition is preferably 0.01 mass % or more and 1 mass % or less, and more preferably 0.05 mass % or more and 1 mass % or less per the total mass of the resin composition.

By setting the content of the phenolic heat stabilizer within the above range, the heat aging resistance of the molded article can be further enhanced, and the amount of gas generation can be further reduced.

### (2) Phosphorus-Based Heat Stabilizers

Examples of phosphorus-based heat stabilizers include the following, but are not limited to, pentaerythritol-type phosphite compound, trioctyl phosphite, trilaurel phosphite, tridecyl phosphite, octyl diphenyl phosphite, tris(isodecyl) phosphite, phenyl diisodecyl phosphite, phenyl di(tridecyl) phosphite, diphenyl isooctyl phosphite, diphenyl isodecyl phosphite, diphenyl(tridecyl) phosphite, triphenyl phosphite, tris(nonylphenyl) phosphite, tris(2,4-di-tert-butylphenyl) phosphite, tris(2,4-di-tert-butyl-5-methylphenyl) phosphite, tris(butoxyethyl) phosphite, 4,4′-butylidenebis(3-methyl-6-tert-butylphenyl tetra-tridecyl) diphosphite, tetra(C12-C15 mixed alkyl)-4,4′-isopropylidenediphenyl diphosphite, 4,4′-isopropylidenebis(2-tert-butylphenyl) di(nonylphenyl) phosphite, tris(biphenyl) phosphite, tetra(tridecyl)-1,1,3-tris(2-methyl-5-tert-butyl-4-hydroxyphenyl) butane diphosphite, tetra(tridecyl)-4,4′-butylidenebis(3-methyl-6-tert-butylphenyl) diphosphite, tetra(C1-C15 mixed alkyl)-4,4′-isopropylidenediphenyl tris(mixed mono- and di-nonylphenyl) phosphite, 4,4′-diphosphite, isopropylidenebis(2-tert-butylphenyl) di(nonylphenyl) phosphite, 9,10-dihydro-9-oxa-10-phosphaphenanthrene-10-oxide, tris(3,5-di-tert-butyl-4-hydroxyphenyl) phosphite, hydrogenated 4,4′-isopropylidenediphenyl polyphosphite, bis(octylphenyl)-bis(4,4′-butylidenebis(3-methyl-6-tert-butylphenyl))-1,6-hexanediol diphosphite, hexatridecyl-1,1,3-tris(2-methyl-4-hydroxy-5-tert-butylphenyl) butane triphosphite, tris(4,4′-isopropylidenebis(2-tert-butylphenyl)) phosphite, tris(1,3-distearoyloxyisopropyl) phosphite, 2,2′-methylenebis(4,6-di-tert-butylphenyl) octyl phosphite, 2,2′-methylenebis(3-methyl-4,6-di-tert-butylphenyl) 2-ethylhexyl phosphite, tetrakis(2,4-di-tert-butyl-5-methylphenyl)-4,4′-biphenylenediphosphite, tetrakis(2,4-di-tert-butylphenyl)-4,4′-biphenylenediphosphite, for example.

One of these phosphorus-based heat stabilizers may be used alone, or two or more of these may be used in combination.

Examples of pentaerythritol-type phosphite compounds include the following, but are not limited to, 2,6-di-tert-butyl-4-methylphenyl-phenyl-pentaerythritol diphosphite, 2,6-di-tert-butyl-4-methylphenyl-methyl-pentaerythritol diphosphite, 2,6-di-tert-butyl-4-methylphenyl-2-ethylhexyl-pentaerythritol diphosphite, 2,6-di-tert-butyl-4-methylphenyl-isodecyl-pentaerythritol diphosphite, 2,6-di-tert-butyl-4-methylphenyl-lauryl-pentaerythritol diphosphite, 2,6-di-tert-butyl-4-methylphenyl-isotridecyl-pentaerythritol diphosphite, 2,6-di-tert-butyl-4-methylphenyl-stearyl pentaerythritol diphosphite, 2,6-di-tert-butyl-4-methylphenyl-cyclohexyl pentaerythritol diphosphite, 2,6-di-tert-butyl-4-methylphenyl-benzyl-pentaerythritol diphosphite, 2,6-di-tert-butyl-4-methylphenyl-ethyl cellosolve pentaerythritol diphosphite, 2,6-di-tert-butyl-4-methylphenyl-butyl-carbitol pentaerythritol diphosphite, 2,6-di-tert-butyl-4-methylphenyl-octylphenyl-pentaerythritol diphosphite, 2,6-di-tert-butyl-4-methylphenyl-nonylphenyl pentaerythritol pentaerythritol diphosphite, bis(2,6-di-tert-butyl-4-methylphenyl) pentaerythritol diphosphite, bis(2,6-di-tert-butyl-4-ethylphenyl) pentaerythritol diphosphite, 2,6-di-tert-butyl-4-methylphenyl-2,6-di-tert-butylphenyl pentaerythritol diphosphite, 2,6-di-tert-butyl-4-methylphenyl-2,4-di-tert-butylphenyl pentaerythritol diphosphite, 2,6-di-tert-butyl-4-methylphenyl-2,4-di-tert-octylphenyl pentaerythritol diphosphite, 2,6-di-tert-butyl-4-methylphenyl-2-cyclohexylphenyl-pentaerythritol diphosphite, 2,6-di-tert-amyl-4-methylphenyl-phenyl-pentaerythritol diphosphite, bis(2,6-di-tert-amyl-4-methylphenyl) pentaerythritol diphosphite, and bis(2,6-di-tert-octyl-4-methylphenyl) pentaerythritol diphosphite, for example.

One of these pentaerythritol-type phosphite compounds may be used alone, or two or more of these may be used in combination.

When a phosphorus-based heat stabilizer is used, the content of the phosphorus-based heat stabilizer in the resin composition is preferably 0.01 mass % or more and 1 mass % or less, and more preferably 0.05 mass % or more and 1 mass % or less with respect to the total mass of the resin composition.

By setting the content of the phosphorus-based heat stabilizer within the above range, the heat aging resistance of the molded article can be further enhanced, and the amount of gas generation can be further reduced.

### (3) Amine-Based Heat Stabilizers

Examples of amine-based heat stabilizers include the following, but are not limited to, 4-acetoxy-2,2,6,6-tetramethylpiperidine, 4-stearoyloxy-2,2,6,6-tetramethylpiperidine, 4-acryloyloxy-2,2,6,6-tetramethylpiperidine, 4-(phenylacetoxy)-2,2,6,6-tetramethylpiperidine, 4-benzoyloxy-2,2,6,6-tetramethylpiperidine, 4-methoxy-2,2,6,6-tetramethylpiperidine, 4-stearoxy-2,2,6,6-tetramethylpiperidine, 4-cyclohexyloxy-2,2,6,6-tetramethylpiperidine, 4-benzyloxy-2,2,6,6-tetramethylpiperidine, 4-phenoxy-2,2,6,6-tetramethylpiperidine, 4-(ethylcarbamoyloxy)-2,2,6,6-tetramethylpiperidine, 4-(cyclohexylcarbamoyloxy)-2,2,6,6-tetramethylpiperidine, 4-(phenylcarbamoyloxy)-2,2,6,6-tetramethylpiperidine, bis(2,2,6,6-tetramethyl-4-piperidyl)-carbonate, bis(2,2,6,6-tetramethyl-4-piperidyl)-oxalate, bis(2,2,6,6-tetramethyl-4-piperidyl)-malonate, bis(2,2,6,6-tetramethyl-4-piperidyl)-sebacate, bis(2,2,6,6-tetramethyl-4-piperidyl)-adipate, bis(2,2,6,6-tetramethyl-4-piperidyl)-terephthalate, 1,2-bis(2,2,6,6-tetramethyl-4-piperidyloxy)-ethane, α,α′-bis(2,2,6,6-tetramethyl-4-piperidyloxy)-p-xylene, bis(2,2,6,6-tetramethyl-4-piperidyl) toluene-2,4-dicarbamate, bis(2,2,6,6-tetramethyl-4-piperidyl)-hexamethylene-1,6-dicarbamate, tris(2,2,6,6-tetramethyl-4-piperidyl)-benzene-1,3,5-tricarboxylate, tris(2,2,6,6-tetramethyl-4-piperidyl)-benzene-1,3,4-tricarboxylate, 1-[2-{3-(3,5-di-tert-butyl-4-hydroxyphenyl) propionyl} butyl]-4-[3-(3,5-di-tert-butyl-4-hydroxyphenyl) propionyl] 2,2,6,6-tetramethylpiperidine, a condensate of 1,2,3,4-butanetetracarboxylic acid and 1,2,2,6,6-pentamethyl-4-piperidinol and β,β,β′,β′-tetramethyl-3,9-[2,4,8,10-tetraoxaspiro(5,5)undecan]-diethanol, for example.

One of these amine-based heat stabilizers may be used alone, or two or more of these may be used in combination.

When an amine-based heat stabilizer is used, the content of the amine-based heat stabilizer in the resin composition is preferably 0.01 mass % or more and 1 mass % or less, and more preferably 0.05 mass % or more and 1 mass % or less, with respect to the total mass of the resin composition.

By setting the content of the amine-based heat stabilizer within the above range, the heat aging resistance of the molded article can be further enhanced, and the amount of gas generation can be further reduced.

### (4) Metal Salts of Elements of Groups 3, 4, and 11 to 14 of the Periodic Table

Metal salts of elements of Groups 3, 4, and 11 to 14 of the Periodic Table are not limited as long as the salts are salts of metals belonging to these groups.

Of these, copper salts are preferred from the perspective of further improving the heat aging resistance of the molded article. Examples of such copper salts include the following, but are not limited to, copper acetate, copper propionate, copper benzoate, copper adipate, copper terephthalate, copper isophthalate, copper salicylate, copper nicotinate, copper stearate, and copper complex salts in which copper is coordinated to chelating agents, for example.

Examples of chelating agents include ethylenediamine and ethylenediaminetetraacetic acid, for example.

One of these copper salts may be used alone, or two or more of these may be used in combination.

Among these, copper acetate is preferred as a copper salt. When a copper salt is used, a resin composition that has more excellent heat aging resistance and that can more effectively control metal corrosion of the screw and the cylinder during extrusion (hereinafter also referred to simply as “metal corrosion”) can be obtained.

When a copper salt is used as a heat stabilizer, the content of the copper salt in the resin composition is preferably 0.01 parts by mass or more and 0.60 parts by mass or less, and more preferably 0.02 parts by mass or more and 0.40 parts by mass or less, per 100 parts by mass of the thermoplastic resin (A).

By setting the content of the copper salt within the above range, the heat aging resistance of the molded article can be further improved, while more effectively suppressing copper precipitation and metal corrosion.

From the perspective of improving the heat aging resistance of the molded product, the concentration of the copper element derived from the above copper salt is preferably 10 parts by mass or more and 2000 parts by mass or less, more preferably 30 parts by mass or more and 1500 parts by mass or less, and even more preferably 50 part by mass or more and 500 parts by mass or less, with respect to 106 parts by mass (million parts by mass) of the thermoplastic resin (A).

One of the heat stabilizer components described above may be used alone, or two or more of these may be used in combination.

### [Method for Producing Resin Composition]

The method for producing the resin composition is not particularly limited as long as it involves mixing each component, namely, the thermoplastic resin (A) with the titanium oxide (B) and, as necessary, the filler (C), the flame retardant (D), the colorant (E), and other additives (F). Hereinafter, the thermoplastic resin (A), the titanium oxide (B), the filler (C), the flame retardant (D), the colorant (E), and other additives (F) are also referred to as component (A), component (B), component (C), component (D), component (E), and component (F), respectively.

Examples of mixing methods for the components (A) and (B), and, as necessary, the components (C) to (F), include the following methods:
(1) A method in which the components (A) and (B), and, as necessary, the components (C) to (F), are mixed using a Henschel mixer or the like and then supplied to a single-screw or twin-screw extruder for melt kneading.
(2) A method in which a mixture of components other than the component (C) is pre-mixed using a Henschel mixer or the like, the obtained mixture is supplied to a single-screw or twin-screw extruder for melt kneading, and then, if necessary, the component (C) is added via the side feeder of the extruder.
(3) A method combining the methods described in (1) and (2).

The method of feeding the components of the resin composition to the melt-kneading machine may be done by feeding all the components simultaneously to the same feed port, or by feeding the components from different feed ports.

When the polyamide (A1) contains an aliphatic polyamide (A1-1), the melt kneading temperature is preferably about at least 1° C. and at most 100° C. higher than the melting point of the aliphatic polyamide (A1-1), more preferably at least 10° C. and at most 50° C. higher than the melting point of the aliphatic polyamide (A1-1).

The shear rate in the kneading machine is preferably about 100 sec-1 or higher. Furthermore, the average residence time during kneading is preferably 0.5 minutes or longer and 5 minutes or shorter.

A known apparatus may be used as the machine for melt-kneading, and examples include, for example, single or twin screw extruders, Banbury mixers, and melt-kneading machines (mixing rolls).

The respective amounts of the components in the resin composition are the same as the respective amounts of the components in the resin composition described above.

### [Physical Properties of Resin Composition]

The glass transition temperature Tg of the resin composition is preferably 75° C. or higher, more preferably 75° C. or higher and 220° C. or lower, even more preferably 80° C. or higher and 200° C. or lower, further preferably 85° C. or higher and 180° C. or lower, particularly preferably 90° C. or higher and 160° C. or lower, and most preferably 92° C. or higher and 150° C. It is preferably 90° C. or higher.

When the glass transition temperature Tg of the resin composition is within the above-described numerical range, the resulting molded article exhibits superior gloss and enhanced clarity of printed markings made by laser marking.

The glass transition temperature Tg of the resin composition can be measured, for example, using a dynamic viscoelasticity measurement device.

Specifically, for example, when a measurement is performed at an applied frequency of 8 Hz while the resin composition is heated from −100° C. to 250° C. at a heating rate of 3° C./min, the peak-top temperature of the peak at which the storage modulus significantly decreases and the loss modulus reaches the maximum is defined as the glass transition temperature Tg. More specifically, the temperature at which tan δ reaches the maximum point is defined as the glass transition temperature Tg, where tan δ is the ratio (E2/E1) of the loss modulus E2 to the storage modulus E1. If two or more loss modulus peaks are observed, the peak temperature of the highest temperature peak is taken as the glass transition temperature Tg. In this measurement, the frequency of measurement shall be at least once every 20 seconds to enhance accuracy.

Although there is no particular limitation on the preparation method of the measurement sample, the sample is preferably prepared in accordance with JIS-K7139. From the perspective of eliminating the effects of molding strain, it is preferable that a cutout piece from a thermally pressed molded article is used to eliminate the effect of molding strain. From the perspective of thermal conductivity, it is preferable that the dimensions (width and thickness) of the cutout piece be as small as possible.

The crystallization peak temperature of the resin composition is preferably 240° C. or lower, more preferably 240° C. or lower or non-existent, even more preferably 120° C. or higher and 235° C. or lower or non-existent, still even more preferably 140° C. or higher and 230° C. or lower or non-existent, and particularly preferably 160° C. or higher and 225° C. or lower or non-existent.

Ensuring that the crystallization peak temperature of the resin composition to fall within the above-described numerical range leads to superior gloss and enhanced clarity of printed markings made by laser marking on the molded article. A non-existent peak temperature is a state in which the influence of the amorphous resin component is significant.

The crystallization peak temperature of the resin composition can be measured using DSC, for example.

Specifically, for example, the peak-top temperature of the observed endothermic peak is defined as the crystallization peak temperature when the resin composition is heated from 40° C. to 300° C. at a heating rate of 20° C./min, maintained at 300° C. for 3 minutes, then cooled from 300° C. to 40° C. at a cooling rate of 20° C./min, maintained at 40° C. for 3 minutes, reheated from 40° C. to 300° C. at a heating rate of 20° C./min, maintained at 300° C. for 3 minutes, and then cooled again from 300° C. to 40° C. at a cooling rate of 20° C./min. If two or more endothermic peaks appear, the peak-top temperature of the highest-temperature endothermic peak is defined as the crystallization peak temperature. The crystallization peak temperature observed in this procedure was measured.

The enthalpy of the endothermic peak observed at this time is preferably 10 J/g or more, and more preferably 20 J/g or more. Additionally, during measurement, it is preferable to heat the sample once to a temperature condition of at least 20° C. above the melting point to melt the resin, then cool the sample to 23° C. at a cooling rate of 10° C./min before use.

### <Method of Manufacturing Molded Article>

The molded article described above can be manufactured using, for example, the following method.

Specifically, the method for manufacturing a molded article having an identification portion of the present embodiment (hereinafter sometimes abbreviated as “the manufacturing method of the present embodiment”) includes performing laser marking (hereinafter referred to as “the laser marking step”) on a molded article formed by molding a resin composition containing a thermoplastic resin (A) and titanium oxide (B).

The resin composition described in the above step has a light absorptivity of 17% or less at a wavelength of 355 nm when formed into a molded product with a thickness of 50 μm, and the laser marking is performed such that the protrusion height of the identification portion of the molded article is 6.6 μm or less.

Since the manufacturing method of the present embodiment has the above configuration, a molded article with a clear printed portion made by laser marking can be obtained.

That is, the manufacturing method of the present embodiment can also be referred to as a laser marking method for imparting a clear printed portion made by laser marking to a molded article.

### [Laser Marking Step]

Examples of lasers used in the laser marking step include carbon dioxide lasers, Nd-YAG lasers, YAG lasers, ruby lasers, semiconductor lasers, argon lasers, and excimer lasers. Among these, from the perspective of marking performance, Nd-YAG lasers, YAG lasers, or semiconductor lasers are preferred.

The wavelength of the laser used is generally preferably 193 nm or more and 1100 nm or less, more preferably within one of the three wavelength bands of 300 nm or more and 400 nm or less, 500 nm or more and 600 nm or less, or 900 nm or more and 1100 nm or less, even more preferably within the two wavelength bands of 300 nm or more and 400 nm and 500 nm or more and 600 nm or less, and further preferably within the wavelength band of 300 nm or more and 400 nm or less.

By processing within these wavelength bands, the titanium oxide (B) that absorbs the laser undergoes a color change to a blackish hue, making the contrast with the surrounding portion clear.

From the perspective of reducing takt time, the scanning speed of laser marking is preferably 10 mm/sec or more and 5000 mm/sec or less, more preferably 100 mm/sec or more and 4000 mm/sec or less, even more preferably 200 mm/sec or more and 3000 mm/sec or less, and particularly preferably 500 mm/sec or more and 2500 mm/sec or less.

By setting the scanning speed to the above-described lower limit or more, excessive laser irradiation on the titanium oxide (B) can be prevented, thereby effectively preventing carbonization of resin or foaming of the surface layer due to heating, concealing the discolored titanium oxide, which could reduce contrast with the surrounding portion, to more effectively prevent the printed markings from becoming unreadable. On the other hand, by setting the scanning speed to the above-described upper limit or less, insufficient laser irradiation can be prevented, thereby effectively preventing a reduction in contrast with the surrounding portion, to more effectively prevent the printed markings from becoming unclear.

The processing output of laser marking is preferably 0.01 W or more and 30.0 W or less, more preferably 0.05 W or more and 20.0 W or less, and even more preferably 0.1 W or more and 15.0 W or less.

By setting the processing output to the above-described lower limit or more, a reduction in contrast due to insufficient laser irradiation of the titanium oxide (B) can be prevented, thereby more effectively preventing the printed markings from becoming unclear. On the other hand, by setting the processing output to the above-described upper limit or less, excessive laser absorption can be prevented, thereby effectively preventing carbonization of resin or foaming of the surface layer due to heating, concealing the discolored titanium oxide, which could reduce contrast with the surrounding portion, to more effectively prevent the printed markings from becoming unreadable.

The frequency of laser marking is preferably 1 kHz or more and 1000 kHz or less, more preferably 5 kHz or more and 750 kHz or less, and even more preferably 10 kHz or more and 500 kHz or less.

Setting the frequency is to the above-described lower limit or more allows for marking without gaps, leading to uniform print density and improved contrast of markings, thereby more effectively preventing the printed markings from becoming unclear. On the other hand, keeping the frequency the above-described upper limit or less ensures that the irradiation energy per pulse remains above a certain level, preventing a reduction in laser irradiation on the titanium oxide (B) that would otherwise decrease the contrast difference with the surrounding portion, thereby more effectively preventing the printed markings from becoming unreadable.

The pitch interval for laser marking is preferably 0.1 μm or more and 500 μm or less, more preferably 1 μm or more and 250 μm or less, and even more preferably 5 μm or more and 250 μm or less.

Keeping the pitch interval the above-described lower limit or more prevents excessively dense laser irradiation, which could lead to carbonization of the resin or foaming of the surface resin layer due to heating, concealing the discolored titanium oxide, which could reduce contrast with the surrounding portion, thereby more effectively preventing the printed markings from becoming unclear. On the other hand, keeping the pitch interval the above-described upper limit or less ensures marking without gaps, leading to uniform print density and improved contrast of markings, thereby more effectively preventing the printed markings from becoming unclear.

### [Molding Step]

The manufacturing method of the present embodiment may further include a molding step prior to the laser marking step.

In the molding step, the above-described resin composition is molded to obtain an intermediate molded article that does not have a printed portion (e.g., the above-described identification portion) made by laser marking.

The method for obtaining the intermediate molded article is not particularly limited, and known molding methods can be used.

Examples of known molding methods include extrusion molding, injection molding, vacuum molding, blow molding, injection compression molding, decoration molding, dual injection molding, gas-assisted injection molding, expansion injection molding, low-pressure molding, ultrathin injection molding (ultrahigh-speed injection molding), and in-mold composite molding (insert molding and outsert molding).

The mold temperature during injection molding is preferably 140° C. or lower, more preferably 130° C. or lower, and even more preferably 120° C. or lower. Additionally, the mold temperature is preferably 35° C. or higher, more preferably 40° C. or higher, and even more preferably 45° C. or higher.

A lower mold temperature during injection molding reduces the crystallinity of the surface layer, increasing the proportion of laser-sensitive colorants that penetrate inside the molded product, thereby improving clarity.

However, if the mold temperature is extremely low (e.g., 30° C. or lower), the surface layer solidifies before the pressure-holding step during injection molding, resulting in an uneven surface. In this state, the surface roughness of the laser marked portion increases, causing light to scatter, which enhances whiteness and suppresses the blackness of the discolored titanium oxide, leading to reduced contrast.

### [Method for Manufacturing Laser-Marked Molded Article]

The method for manufacturing a laser-marked molded article of the present embodiment includes a step of performing laser marking on a molded article formed by molding a resin composition containing a thermoplastic resin (A).

The resin composition has a light reflectance of 17% or less at a wavelength of 355 nm when formed into a molded product with a thickness of 50 μm.

The resin composition may be similar to the resin composition in the molded article of the present embodiment described above, and a similar resin composition is preferable. The molded article may be the molded article of the present embodiment described above. The step of performing laser marking may have a step similar to the laser marking step in the method for manufacturing a molded article of the present embodiment described above, and a similar step is preferable.

The laser-marked molded article may be a molded article in which an identification portion is provided by a laser.

### [Laser Marking Method]

The laser marking method of the present embodiment is a method of laser marking a molded article formed by molding a resin composition containing a thermoplastic resin (A).

The resin composition has a light reflectance of 17% or less at a wavelength of 355 nm when formed into a molded product with a thickness of 50 μm.

The resin composition may be similar to the resin composition in the molded article of the present embodiment described above, and a similar resin composition is preferable. The molded article may be the molded article of the present embodiment described above.

The method of laser marking may have a step similar to the laser marking step in the method for manufacturing a molded article of the present embodiment described above, and a similar step is preferable.

A molded article that has undergone laser marking by the laser marking method of the present embodiment may be a molded article in which an identification portion is provided by a laser.

### <Application of Molded Article>

Since the molded article of the present embodiment has a clear printed portion made by laser marking, it can be used for various applications.

The molded article of the present embodiment is suitably used, for example, in the fields of automobiles, electricity and electronics, machinery and industry, office equipment, and aerospace.

In particular, the molded article of the present embodiment is suitably used as an electrical or electronic component, such as a housing for a magnetic switch, a housing for a breaker, various switch components, and a molded article for a connector, and is more suitably used for a housing for a magnetic switch, a housing for a breaker, or a molded article for a connector.

Electromagnetic contactors that open and close electrical circuits using an electromagnet, thermal relays that cut off circuits in case of overload, electromagnetic switches combining these (which have multiple names. such as magnet switches and air circuit breakers), and safety breakers or leakage breakers that cut off the power supply when a current exceeding a specified value is flowed or when abnormalities such as vibrations or overheating are detected (hereinafter collectively referred to as “breakers”) are electrical or electronic components incorporated into electrical wiring and are essential for ensuring safety of electrical wiring.

These electrical and electronic components require markings for product identification, connection notation to prevent installation errors, and safety-related labeling. Conventionally, adhesive labels are applied for such markings, but this method has restrictions, such as requiring a smooth surface on the molded article. Therefore, the shift from conventional adhesive labeling to laser marking is progressing in these products as well, and clear marking characteristics are required.

That is, the molded article of the present embodiment is suitably used in the above-described electrical and electronic components, where clear marking characteristics are required.

### EXAMPLES

The following provides a more detailed description of the present disclosure through specific examples and comparative examples. However, the present disclosure is not limited to the following examples.

The components of the resin composition used in the molded articles of the examples and comparative examples will be described below.

### <Components>

### [Thermoplastic Resin (A)]

A1-1: Polyamide 66, aliphatic polyamide
A1-2-1: Polyamide 6I, semi-aromatic polyamide
A1-2-2: Polyamide 6I/6T (manufactured by EMS, trade number: G21, content of isophthalic acid units in all dicarboxylic acid units of 70 mol %, molecular weight: 27,000), semi-aromatic polyamide
A1-2-3: Polyamide 66/6I, copolymer, semi-aromatic polyamide
A2: Polybutylene terephthalate

### [Titanium Oxide (B)]

B-1: Titanium oxide (rutile type, surface treatment agents: alumina, silica, average particle size: 210 nm, oil absorption: 15 g/100 g)

### [Filler (C)]

C-1: Glass fibers (GF) (trade name: “ECS03T275H”, manufactured by Nippon Electric Glass Co., Ltd., average fiber diameter: 10 μm, number average fiber length: 3 mm)

### [Flame Retardant (D)]

D-1: Phosphinic acid-based flame retardant, aluminum diethyl phosphinate (manufactured by Clariant, trade name: “Exolit OP1230”)
D-2: Brominated polystyrene (manufactured by Chemtura Japan Limited, PBS-64HW)
D-3: Antimony trioxide (manufactured by Yamanaka & Co., Ltd., GMA)

### [Colorant (E)]

E-1: Carbon black (primary particle size: 27 nm) E-2: Zinc sulfide (particle size: 300 nm)
E-3: Pigment Violet 15

### <Production of Polyamides>

The production methods of an aliphatic polyamide A1-1, a semi-aromatic polyamide A1-2-1, and a semi-aromatic polyamide A1-2-3 are detailed below. The aliphatic polyamide A1-1, the semi-aromatic polyamide A1-2-1, and the semi-aromatic polyamide A1-2-3 obtained through the following production methods were dried in a nitrogen stream so that the moisture content was adjusted to about 0.2 mass % before being used as raw materials for the resin compositions in the molded articles of the examples and comparative examples described later.

### Synthesis Example 1

### (Synthesis of Aliphatic Polyamide A1-1 (Polyamide 66))

A polymerization reaction of the polyamide was carried out by the “thermal melting polymerization method” as follows.

First, a 50 mass % homogeneous equimolar water solution of raw monomers was prepared by dissolving 1500 g of an equimolar salt of adipic acid and hexamethylenediamine in 1500 g of distilled water. The water solution was charged in an autoclave with a content of 5.4 L, which was replaced with nitrogen. Next, the solution was concentrated by gradually venting water vapor until the concentration of the solution reached 70 mass % while stirring at a temperature of about 110° C. or higher and 150° C. or lower. The internal temperature was then raised to 220° C. At this time, the pressure of the autoclave was increased to 1.8 MPa. A reaction was caused to take place for 1 hour while the pressure was maintained at 1.8 MPa until the internal temperature reached 245° C. by gradually venting water vapor for 1 hour. The pressure was then lowered over 1 hour. The interior of the autoclave was then maintained at a reduced pressure of 650 torr (86.66 kPa) for 10 minutes using a vacuum apparatus. At this time, the final internal temperature of the polymerization was 265° C. The resultant was then extruded by pressurization with nitrogen through a lower spinneret (nozzle) into strands, which were water-cooled, cut, and discharged in the form of pellets. Thereafter, the pellets were dried at 100° C. for 12 hours under a nitrogen atmosphere to obtain an aliphatic polyamide A1-1 (polyamide 66).

### Synthesis Example 2

### (Synthesis of Semi-Aromatic Polyamide (A1-2-1) (Polyamide 6I))

A polymerization reaction of the polyamide was carried out by the “thermal melting polymerization method” as follows.

First, a 50 mass % homogeneous water solution of raw monomers was prepared by dissolving, in 1500 g of distilled water, 1500 g of an equimolar salt of isophthalic acid and hexamethylenediamine, and 1.5 mol % excess adipic acid with respect to the total equimolar salt component and 0.5 mol % of acetic acid. Next, the solution was concentrated by gradually venting water vapor until the concentration of the solution reached 70 mass % while stirring at a temperature of about 110° C. or higher and 150° C. or lower. The internal temperature was then raised to 220° C. At this time, the pressure of the autoclave was increased to 1.8 MPa. A reaction was caused to take place for 1 hour while the pressure was maintained at 1.8 MPa until the internal temperature reached 245° C. by gradually venting water vapor for 1 hour. The pressure was then lowered over 30 minutes. The interior of the autoclave was then maintained at a reduced pressure of 650 torr (86.66 kPa) for 10 minutes using a vacuum apparatus. At this time, the final internal temperature of the polymerization was 265° C. The resultant was then extruded by pressurization with nitrogen through a lower spinneret (nozzle) into strands, which were water-cooled, cut, and discharged in the form of pellets Thereafter, the pellets were dried at 100° C. for 12 hours under a nitrogen atmosphere to obtain a semi-aromatic polyamide (A1-2-1) (polyamide 6I).

### Synthesis Example 3

### (Synthesis of Semi-Aromatic Polyamide A1-2-3 (Polyamide 66/6I))

A 5 L autoclave was charged with 2.00 kg of an equimolar salt of adipic acid and hexamethylenediamine, 0.50 kg of an equimolar salt of isophthalic acid and hexamethylenediamine, and 2.5 kg of purified water, followed by thorough stirring. After sufficient nitrogen substitution, the temperature was raised from room temperature to 220° C. over about 1 hour while stirring. At this time, the internal pressure of the autoclave reached 18 kg/cm²G due to the natural pressure of water vapor inside the autoclave, and water was removed from the reaction system while continuing heating to prevent the pressure from reaching 18 kg/cm²G or higher. After an additional 2 hours, when the internal temperature reached 260° C., heating was stopped. The discharge valve of the autoclave was closed, and the system was cooled to room temperature over approximately 8 hours. After cooling, the autoclave was opened, and about 2 kg of the polymer was removed and pulverized. The obtained pulverized polymer was placed in a 10 L evaporator and subjected to solid-state polymerization at 200° C. for 10 hours under a nitrogen stream. The resultant was then extruded by pressurization with nitrogen through a lower spinneret (nozzle) into strands, which were water-cooled, cut, and discharged in the form of pellets Thereafter, the pellets were dried at 100° C. for 12 hours under a nitrogen atmosphere to obtain a semi-aromatic polyamide A1-2-3 (polyamide 66/6I copolymer).

### <Production of Resin Composition>

### Production Example 1

A twin screw extruder TEM58SS manufactured by Toshiba Machine Co., Ltd., (set temperature: 280° C., screw rotation speed: 300 rpm) was used. Through the top feed port installed at the most upstream part of the extruder, a pre-blended mixture of the aliphatic polyamide A1-1, the semi-aromatic polyamide A1-2-1, and the titanium oxide (B-1) was supplied. Next, the melt-kneaded mixture extruded from the die head was cooled into strands and pelletized to obtain resin composition pellets. The blending ratios (parts by mass) are as summarized in Table 1.

### Production Examples 2 to 25

Each resin composition was produced using the same method as described in Production Example 1, except that the blending ratios of the components (A) to (E) were as summarized in Tables 1 and 2, and the titanium oxide B-1 was supplied through the side feed port located downstream of the extruder (where the resin supplied from the top feed port had sufficiently melted).

In Production Example 24, the resin composition was produced using the same method as described in Production Example 1, except that the set temperature of the twin-screw extruder was changed to 250° C.

TABLE 1

| Production Example | | | 1 | 2 | 3 | 4 | 5 | 6 | 7 |
|---|---|---|---|---|---|---|---|---|---|
| Thermoplastic resin (A) | Aliphatic polyamide (A1-1) | pt. by mass | 13.0 | 13.0 | 29.0 | 73.0 | 90.0 | 72.0 | — |
| | Semiaromatic polyamide (A1-2-1) | pt. by mass | 87.0 | 87.0 | 71.0 | 27.0 | 10.0 | 28.0 | — |
| | Semiaromatic polyamide (A1-2-2) | pt. by mass | — | — | — | — | — | — | — |
| | Semiaromatic polyamide (A1-2-3) | pt. by mass | — | — | — | — | — | — | 100.0 |
| Titanium oxide (B) | Titanium oxide (B-1) | pt. by mass | 1.120 | 1.120 | 1.350 | 1.350 | 1.350 | 1.890 | 1.330 |
| Filler (C) | Glass fiber (C-1) | pt. by mass | — | 11.0 | 33.3 | 33.3 | 33.0 | 100.0 | 33.3 |
| Flame retardant (D) | Phosphorus-based flame | pt. by mass | — | — | — | — | — | — | — |
| | retardant (D-1) | | | | | | | | |
| Colorant (E) | Carbon black (E-1) | pt. by mass | — | — | — | — | — | — | — |
| | Zinc sulfide (E-2) | pt. by mass | — | — | — | — | — | — | — |
| | Pigment Violet 15(E-3) | pt. by mass | — | — | — | — | — | — | — |

| | | | | | | | | |
|---|---|---|---|---|---|---|---|---|
| Total | pt. by mass | 101.120 | 112.120 | 134.650 | 134.650 | 134.350 | 201.890 | 134.630 |

| Production Example | | | 8 | 9 | 10 | 11 | 12 | 13 | 14 |
|---|---|---|---|---|---|---|---|---|---|
| Thermoplastic resin (A) | Aliphatic polyamide (A1-1) | pt. by mass | — | 9.5 | 80.0 | 80.0 | 80.0 | 80.0 | 80.0 |
| | Semiaromatic polyamide (A1-2-1) | pt. by mass | — | — | 20.0 | 20.0 | 20.0 | 20.0 | 20.0 |
| | Semiaromatic polyamide (A1-2-2) | pt. by mass | — | 90.5 | — | — | — | — | — |
| | Semiaromatic polyamide (A1-2-3) | pt. by mass | 100.0 | — | — | — | — | — | — |
| Titanium oxide (B) | Titanium oxide (B-1) | pt. by mass | 2.000 | 1.900 | 0.920 | 1.380 | 1.830 | 4.600 | 9.170 |
| Filler (C) | Glass fiber (C-1) | pt. by mass | 100.0 | 100.0 | 46.0 | 46.0 | 46.0 | 46.0 | 46.0 |
| Flame retardant (D) | Phosphorus-based flame | pt. by mass | — | — | 37.0 | 37.0 | 37.0 | 37.0 | 37.0 |
| | retardant (D-1) | | | | | | | | |
| Colorant (E) | Carbon black (E-1) | pt. by mass | — | — | — | — | — | — | — |
| | Zinc sulfide (E-2) | pt. by mass | — | — | — | — | — | — | — |
| | Pigment Violet 15(E-3) | pt. by mass | — | — | — | — | — | — | — |

| | | | | | | | | |
|---|---|---|---|---|---|---|---|---|
| Total | pt. by mass | 202.000 | 201.900 | 183.920 | 184.380 | 184.830 | 187.600 | 192.170 |

TABLE 2

| Production Example | | | 15 | 16 | 17 | 18 | 19 | 20 |
|---|---|---|---|---|---|---|---|---|
| Thermoplastic resin (A) | Aliphatic polyamide (A1-1) | pt. by mass | 80.0 | 80.0 | 80.0 | 80.0 | 80.0 | 60.0 |
| | Semiaromatic polyamide (A1-2-1) | pt. by mass | 20.0 | 20.0 | 20.0 | 20.0 | 20.0 | 40.0 |
| | Semiaromatic polyamide (A1-2-2) | pt. by mass | — | — | — | — | — | — |
| | Semiaromatic polyamide (A1-2-3) | pt. by mass | — | — | — | — | — | — |
| | Polybutylene terephthalate (A2) | pt. by mass | — | — | — | — | — | — |
| Titanium oxide (B) | Titanium oxide (B-1) | pt. by mass | — | — | 0.480 | 1.380 | 5.160 | 2.600 |
| Filler (C) | Glass fiber (C-1) | pt. by mass | 46.0 | 46.0 | 46.0 | 46.0 | 46.0 | 130.0 |
| Flame retardant (D) | Phosphorus-based flame retardant (D-1) | pt. by mass | 37.0 | 37.0 | 37.0 | 37.0 | 37.0 | 27.0 |
| | Brominated polystyrene (D-2) | pt. by mass | — | — | — | — | — | — |
| | Antimony trioxide (D-3) | pt. by mass | — | — | — | — | — | — |
| Colorant (E) | Carbon black (E-1) | pt. by mass | — | — | 0.005 | 0.018 | — | — |
| | Zinc sulfide (E-2) | pt. by mass | — | 1.835 | — | — | — | — |
| | Pigment Violet 15(E-3) | pt. by mass | — | — | — | 0.440 | 0.070 | — |

| | | | | | | | |
|---|---|---|---|---|---|---|---|
| Total | pt. by mass | 183.000 | 184.835 | 183.485 | 184.838 | 188.230 | 259.600 |

| Production Example | | | 21 | 22 | 23 | 24 | 25 |
|---|---|---|---|---|---|---|---|
| Thermoplastic resin (A) | Aliphatic polyamide (A1-1) | pt. by mass | 100.0 | 100.0 | 100.0 | — | — |
| | Semiaromatic polyamide (A1-2-1) | pt. by mass | — | — | — | — | — |
| | Semiaromatic polyamide (A1-2-2) | pt. by mass | — | — | — | — | — |
| | Semiaromatic polyamide (A1-2-3) | pt. by mass | — | — | — | — | — |
| | Polybutylene terephthalate (A2) | pt. by mass | — | — | — | 100.0 | 100.0 |
| Titanium oxide (B) | Titanium oxide (B-1) | pt. by mass | 1.350 | 2.000 | 1.900 | 1.830 | 7.500 |
| Filler (C) | Glass fiber (C-1) | pt. by mass | 33.3 | 100.0 | 48.0 | 46.0 | 22.0 |
| Flame retardant (D) | Phosphorus-based flame retardant (D-1) | pt. by mass | — | — | 42.0 | — | — |
| | Brominated polystyrene (D-2) | pt. by mass | — | — | — | — | 15.0 |
| | Antimony trioxide (D-3) | pt. by mass | — | — | — | — | 5.4 |
| Colorant (E) | Carbon black (E-1) | pt. by mass | — | — | — | — | — |
| | Zinc sulfide (E-2) | pt. by mass | — | — | — | — | — |
| | Pigment Violet 15(E-3) | pt. by mass | — | — | — | — | — |

| | | | | | | |
|---|---|---|---|---|---|---|
| Total | pt. by mass | 134.650 | 202.000 | 191.900 | 147.830 | 149.900 |

### <Physical Properties and Evaluation>

First, the pellets of each resin composition obtained in Production Examples 1 to 25 were dried in a nitrogen gas stream, reducing the moisture content in the resin composition to 500 ppm by mass or less. Next, various physical properties of the pellets of each resin composition with adjusted moisture content were measured using the methods described below. Additionally, various physical properties and evaluations were conducted on the molded articles described later.

### [Physical Property 1]

### (Glass Transition Temperature Tg)

The pellets of each resin composition obtained in Production Examples 1 to 25 were molded using an injection molding machine (ROBOSHOT S-2000i, manufactured by FANUC Corporation) by setting a mold temperature set to either 30° C., 60° C., or 80° C., under the injection molding conditions of a cylinder temperature of 290° C., an injection time of 10 seconds, and a cooling time of 10 seconds to produce a molded article in accordance with JIS-K7139.

These molded articles in Production Examples 1 to 24 were evaluated using a dynamic viscoelastic analyzer (EPLEXOR 500N, manufactured by GABO) under the following conditions:

### (Measurement Conditions)

Measurement mode: Tensile
Measurement frequency: 8 Hz
Heating rate: 3° C./min
Temperature range: −100° C. or higher and 250° C. or lower

The temperature at which tan δ reached the maximum was used as the glass transition temperature Tg (° C.), where tan δ is the ratio (E2/E1) of the loss modulus (E2) to the storage modulus (E1).

### [Physical Property 2]

### (Crystallization Peak Temperature)

The crystallization peak temperature was measured in accordance with JIS-K7121 using a Diamond-DSC (manufactured by PerkinElmer) as follows. This measurement was conducted in a nitrogen atmosphere.

First, about 10 mg of the resin composition was heated from 40° C. to 300° C. at a heating rate of 20° C./min. Then, the resin composition was held at 300° C. for 3 minutes before being cooled from 300° C. to 40° C. at a cooling rate of 20° C./min. After being maintained at 40° C. for 3 minutes, the resin composition was reheated from 40° C. to 300° C. at a heating rate of 20° C./min. Finally, the resin composition was held at 300° C. for 3 minutes before being cooled from 300° C. to 40° C. at a cooling rate of 20° C./min. The crystallization peak temperature (° C.) observed during this procedure was recorded.

### [Physical Property 3]

(Light Absorptivity at Wavelength of 355 nm when Thickness was 50 μm)

The pellets of each resin composition obtained in Production Examples 1 to 25 were molded into a flat plate specimen (9 cm×6 cm, thickness: 2 mm) using an injection molding machine (ROBOSHOT S-2000i, manufactured by FANUC Corporation) under the conditions of a cooling time of 15 seconds, a screw rotation speed of 100 rpm, a cylinder temperature of 290° C., and a mold temperature of 80° C. by appropriately adjusting the injection pressure and injection speed so that the filling time remained within the range of 0.5±0.1 seconds.

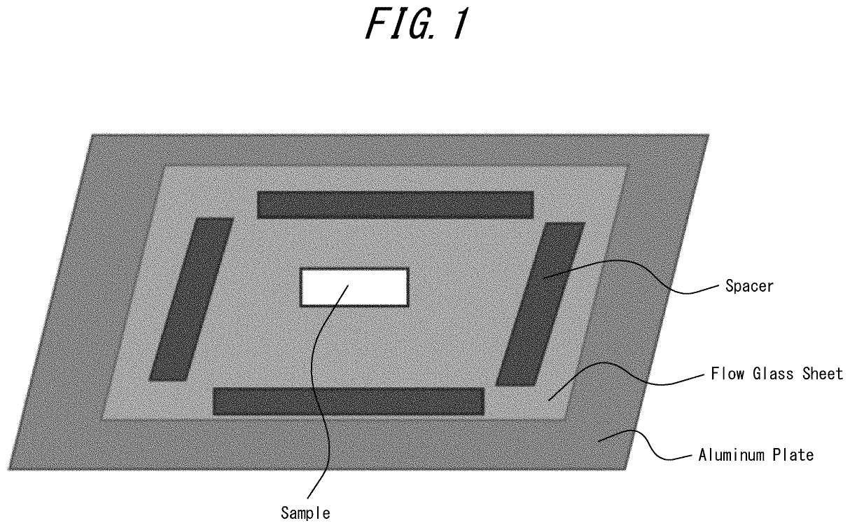

A small piece was cut out from the molded plate specimen, and the test piece was placed in the structure illustrated in FIG. 1. The test piece was heated and compressed using a hot press (a heating and cooling two-stage press, manufactured by Tester Sangyo Co., Ltd., capacity: 70 ton), and stretched to a thickness of 50 μm. The processing conditions for hot pressing were as follows. Heating temperature: 300° C. (Production Examples 1 to 23) or 270° C. (Production Examples 24 to 25) for both upper and lower platens
Step 1: The sample was placed in the heating section and preheated for 6 minutes (maintained in a state where the upper and lower platens were brought close together without applying compressive force to the sample).
Step 2: A first-stage pressing was carried out at 2 MPa (as indicated by the reading of the pressure gauge of the apparatus), held for 3 minutes.
Step 3: A second-stage pressing was carried out at 5 MPa (as indicated by the reading of the pressure gauge of the apparatus), held for 3 minutes.
Step 4: A third-stage pressing was carried out at 8 MPa (as indicated by the reading of the pressure gauge of the apparatus), held for 2 minutes.
Step 5: The sample was transferred to the cooling section and maintained under a pressure of 8 MPa (as indicated by the reading of the pressure gauge of the apparatus). The sample was removed after the cooling water temperature dropped to 40° C. or lower.

The hot pressed sample was taken out and cut into a size suitable for setting in a spectrophotometer (V-670, JASCO Corporation, an integrating sphere “ILN-725” was used). The light transmittance and light reflectance at a wavelength of 355 nm were measured using the above spectrophotometer. The light absorptivity (%) was calculated by subtracting these measurement results from 100%.

FIG. 1 is the arrangement diagram of the sample with a thickness of 50 μm. Only the layers below the sample are illustrated in FIG. 1. In actual hot pressing, a fluoroglass sheet and an aluminum plate were additionally placed above the sample illustrated in FIG. 1.

The size of the cut test pieces and the placement of shim tape (manufactured by Misumi Corporation, thickness: 50 μm) as a spacer were appropriately adjusted so that the thickness of the sample after hot pressing was 50 μm.

### [Evaluation of Light Absorption by Titanium Oxide]

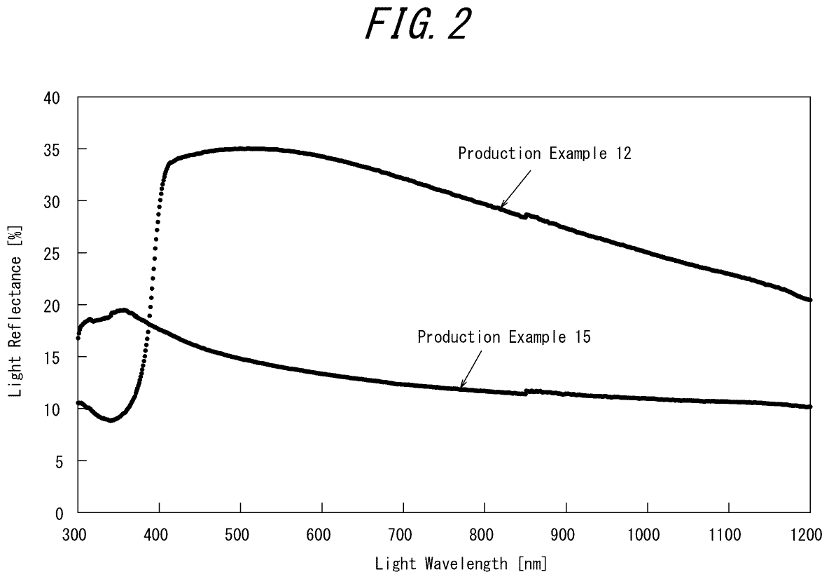

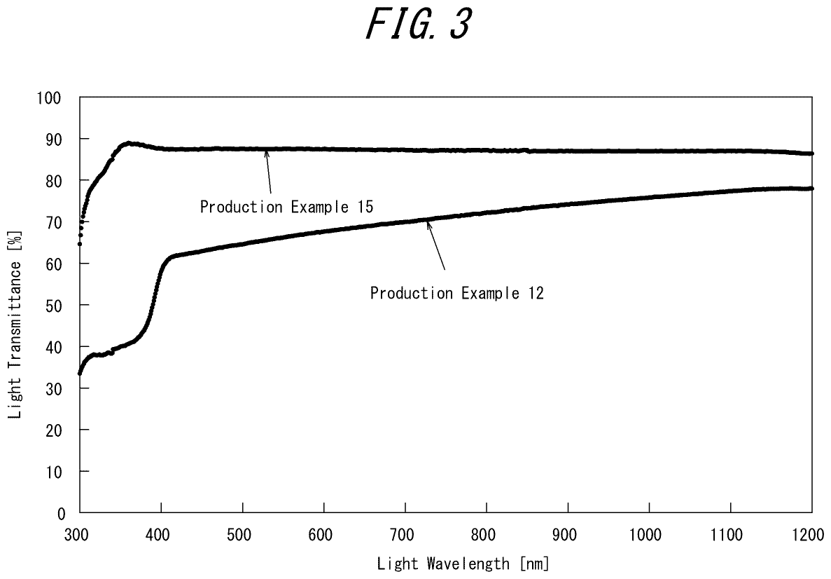

To evaluate the effect of light absorption by titanium oxide, flat plates were prepared using the above method in Production Examples 12 and 15, and samples with a thickness of 50 μm were prepared from small pieces cut out from these flat plates. The light transmittance and light reflectance of these two samples were measured in the wavelength range of 300 nm to 1200 nm. The measurement results are illustrated in FIGS. 2 and 3. These results indicate that the transmittance and reflectance of Production Example 12 rapidly decreased in the wavelength region of 400 nm or shorter, suggesting that titanium oxide absorbed light in this wavelength band.

### Evaluation 1

### (Glossiness)

The 60-degree gloss (%) of the central part of each molded article (portion without printed markings made by laser marking) was measured using a gloss meter (HORIBA, IG-320) in accordance with JIS-K7150. A higher measured value indicates better glossiness.

### Evaluation 2

### (Color Difference)

The chromaticity of both the printed portion made by laser marking and the unprinted portion (unprocessed portion) adjacent thereto of each molded article was measured using a color meter (SC-50μ, manufactured by Suga Test Instruments) with D65 light at an angle of 10°. The lightness (L*), chromaticity (a*, b*) of both the printed portion made by laser marking and the unprinted portion (unprocessed portion) adjacent thereto were measured, and the color difference ΔE* was calculated based on the differences (ΔL*, Δa*, Δb*). A larger color difference ΔE* indicates superior clarity of printed markings made by laser marking.

### [Physical Property 3]

### (Developed Interfacial Area Ratio Sdr of the Interface of Printed Portion Made by Laser Marking)

The developed interfacial area ratio Sdr of the interface of the printed portion made by laser marking of each molded article was measured using a laser microscope (measurement unit: VK-X210, controller: VK-X200, manufactured by Keyence Corporation) at an objective lens magnification of 20× in expert mode in accordance with ISO 25178.

### [Physical Property 4]

### (Protrusion Height of Printed Portion Made by Laser Marking)

The average heights of the printed portion made by laser marking and the vicinity thereof in each molded article were measured using a laser microscope manufactured by Keyence Corporation (Measurement unit: VK-X210, Controller: VK-X200) at an objective lens magnification of 20× in expert mode through the average step height measurement method.

### <Manufacturing of Molded Article]

### Examples 1 to 22 and Comparative Examples 1 to 7

Flat plate molded pieces (9 cm×6 cm, thickness: 2 mm) were prepared from the pellets of each resin composition obtained in Production Examples 1 to 25 using an injection molding machine (ROBOSHOT S-2000i manufactured by FANUC Corporation) under the conditions of a cooling time of 15 seconds, a screw rotation speed of 100 rpm, a cylinder temperature of 290° C. (Production Examples 1 to 23) or 260° C. (Production Examples 24 to 25), and a mold temperature of 80° C. by appropriately adjusting the injection pressure and injection speed so that the filling time was within the range of 0.5±0.1 seconds.

Next, laser marking was applied to the obtained flat plate molded pieces to create a square print of 3 mm×3 mm, thereby obtaining each molded article. The laser marking conditions were set follows: a wavelength of 355 nm (model used: MD-U1000 manufactured by Keyence Corporation), 1064 nm (model used: MD-X2000A manufactured by Keyence Corporation), or 10600 nm (model used: ML-Z9610 manufactured by Keyence Corporation), a scanning speed of 1100 to 1700 mm/s, an output of 0.5 W, 0.75 W, or 1.0 W, a processing frequency of 40 kHz, and a processing pitch of 25 μm. In Examples 21 and 22, the output was set to 1.75 W, 2.00 W, or 2.25 W.

The measurement results and evaluation results of the physical properties of each molded article by the above-described methods are summarized in Tables 3 to 5.

TABLE 3

| | | | Ex. 1 | Ex. 2 | Ex. 3 | Ex. 4 | Ex. 5 | Ex. 6 | Ex. 7 |
|---|---|---|---|---|---|---|---|---|---|
| Production Example | | | 1 | 2 | 3 | 4 | 5 | 6 | 7 |
| Mold temp. during injection molding | | °C | 80 | 80 | 80 | 80 | 80 | 80 | 80 |
| Tg | Viscoelasticity measurement | °C | 129 | 129 | 117 | 107 | 100 | 107 | 102 |
| Crystallization peak temp. | Cooling rate: 20 °C/min | °C | No peak | No peak | 188.0 | 203.5 | 213.0 | 209.5 | 192.6 |
| Transmittance (355 nm) | | % | 63 | 55 | 38 | 25.4 | 19.4 | 14.1 | 17.2 |
| Light reflectance (355 nm) | | % | 10.2 | 9.8 | 9.6 | 10.6 | 10.1 | 9.5 | 9.6 |
| Light absorptivity (355 nm) | | % | 26.8 | 35.2 | 52.4 | 64.0 | 70.5 | 76.4 | 73.2 |
| Laser marking conditions | Wavelength | nm | 355 | 355 | 355 | 355 | 355 | 355 | 355 |
| | Scanning rate | mm/sec | 1700 | 1700 | 1700 | 1700 | 1600 | 1700 | 1700 |
| Lightness of unprinted portion (L*) | | — | 89.5 | 88.1 | 87.2 | 86.4 | 85.9 | 87.5 | 86.1 |
| Color difference: ΔE* | Output condition of 0.5 W | — | 27.2 | 26.0 | 25.5 | 31.1 | 25.6 | 26.2 | 27.0 |
| | Output condition of 0.75 W | — | 29.5 | 29.2 | 28.2 | 29.4 | 31.5 | 29.7 | 31.6 |
| | Output condition of 1.0 W | — | 25.2 | 24.7 | 23.5 | 22.3 | 29.3 | 28.8 | 31.7 |
| Developped interfacial area | Output condition of 0.5 W | — | 0.11 | 0.11 | 0.14 | 0.14 | 0.12 | 0.19 | 0.11 |
| ratio (Sdr) | Output condition of 0.75 W | — | 0.12 | 0.12 | 0.17 | 0.13 | 0.16 | 0.24 | 0.13 |
| | Output condition of 1.0 W | — | 0.16 | 0.15 | 0.18 | 0.19 | 0.30 | 0.32 | 0.17 |
| Protrusion height | Output condition of 0.5 W | mm | 0.09 | 0.09 | 1.38 | 0.20 | 1.81 | 2.85 | 0.16 |
| | Output condition of 0.75 W | mm | 1.00 | 1.43 | 0.96 | 0.63 | 2.29 | 4.13 | 0.09 |
| | Output condition of 1.0 W | mm | 3.89 | 3.06 | 3.62 | 2.51 | 3.75 | 5.01 | 0.68 |
| Glossiness | 60 degrees | % | 87.0 | 87.0 | 85.5 | 85.0 | 81.7 | 70.2 | 86.0 |
| | | | Ex. 8 | Ex. 9 | Ex. 10 | Ex. 11 | Ex. 12 | Ex. 13 | Ex. 14 |
| Production Example | | | 8 | 9 | 10 | 11 | 12 | 12 | 13 |
| Mold temp. during injection molding | | °C | 80 | 80 | 80 | 80 | 80 | 60 | 80 |
| Tg | Viscoelasticity measurement | °C | 102 | 124 | 98 | 98 | 98 | 98 | 98 |
| Crystallization peak temp. | Cooling rate: 20 °C/min | °C | 210.9 | 217 | 208.9 | 209.1 | 209.3 | 209.0 | 209.0 |
| Transmittance (355 nm) | | % | 16.3 | 13.2 | 34.2 | 15.9 | 27.4 | 7.3 | 7.3 |
| Light reflectance (355 nm) | | % | 9.2 | 11.4 | 10.8 | 10.1 | 9.5 | 8.5 | 8.5 |
| Light absorptivity (355 nm) | | % | 74.5 | 75.4 | 55.0 | 74.0 | 63.1 | 84.2 | 84.2 |
| Laser marking conditions | Wavelength | nm | 355 | 355 | 355 | 355 | 355 | 355 | 355 |
| | Scanning rate | mm/sec | 1700 | 1700 | 1700 | 1700 | 1700 | 1700 | 1700 |
| Lightness of unprinted portion (L*) | | — | 89.1 | 82.3 | 87.2 | 87.1 | 70.1 | 87.0 | 69.8 |
| Color difference: ΔE* | Output condition of 0.5 W | — | 24.0 | 21.5 | 23.4 | 24.5 | 28.2 | 30.1 | 23.0 |
| | Output condition of 0.75 W | — | 28.9 | 22.8 | 26.8 | 25.0 | 25.5 | 28.2 | 24.5 |
| | Output condition of 1.0 W | — | 29.3 | 22.6 | 25.5 | 23.2 | 24.1 | 26.1 | 23.5 |
| Developped interfacial area | Output condition of 0.5 W | — | 0.11 | 0.31 | 0.09 | 0.07 | 0.13 | 0.08 | 0.17 |
| ratio (Sdr) | Output condition of 0.75 W | — | 0.16 | 0.38 | 0.13 | 0.14 | 0.22 | 0.14 | 0.27 |
| | Output condition of 1.0 W | — | 0.27 | 0.45 | 0.22 | 0.21 | 0.31 | 0.20 | 0.33 |
| Protrusion height | Output condition of 0.5 W | mm | 3.06 | 3.20 | 1.94 | 2.45 | 2.87 | 2.50 | 1.37 |
| | Output condition of 0.75 W | mm | 2.37 | 4.50 | 2.10 | 2.17 | 3.04 | 2.75 | 1.45 |
| | Output condition of 1.0 W | mm | 4.16 | 5.50 | 2.68 | 2.96 | 2.90 | 2.83 | 2.04 |
| Glossiness | 60 degrees | % | 83.3 | 67.5 | 79.0 | 78.3 | 77.8 | 68.0 | 78.7 |

TABLE 4

| | | | Comp. | Comp. | Comp. | | | | |
|---|---|---|---|---|---|---|---|---|---|
| | | | Ex. 1 | Ex. 2 | Ex. 3 | Ex. 15 | Ex. 16 | Ex. 17 | Ex. 18 |
| Production Example | | | 15 | 16 | 17 | 18 | 20 | 21 | 22 |
| Mold temp. during injection molding | | °C | 80 | 80 | 80 | 80 | 80 | 80 | 80 |
| Tg | Viscoelasticity measurement | °C | 98 | 98 | 98 | 98 | 113 | 85 | 87 |
| Crystallization peak temp. | Cooling rate: 20 °C/min | °C | 119.1 | 209.6 | 211.3 | 212.5 | 199.1 | 221.0 | 223.0 |
| Transmittance (355 nm) | | % | 82.1 | 33.5 | 30.4 | 15.9 | 18.7 | 19.8 | 12.8 |
| Light reflectance (355 nm) | | % | 17.5 | 41.7 | 11.3 | 10.1 | 9.4 | 12.9 | 10.9 |
| Light absorptivity (355 nm) | | % | 0.4 | 24.8 | 58.3 | 74.0 | 71.9 | 67.3 | 76.3 |
| Laser marking conditions | Wavelength | nm | 355 | 355 | 355 | 355 | 355 | 355 | 355 |
| | Scanning rate | mm/sec | 1700 | 1700 | 300 | 1700 | 1700 | 1700 | 1700 |
| Lightness of unprinted portion (L*) | | — | 67.0 | 69.8 | 67.6 | 85.5 | 90.7 | 87.1 | 87.6 |
| Color difference: ΔE* | Output condition of 0.5 W | — | Not | Not | 4.7 | 24.7 | 23.2 | 19.9 | 20.3 |
| | | | printable | printable | | | | | |
| | Output condition of 0.75 W | — | Not | Not | 7.5 | 24.0 | 25.3 | 23.0 | 20.9 |
| | | | printable | printable | | | | | |
| | Output condition of 1.0 W | — | Not | Not | 8.9 | 21.0 | 25.7 | 23.3 | 19.5 |
| | | | printable | printable | | | | | |
| | Output condition of 5.0 W | — | — | — | — | — | — | — | — |
| Developped interfacial area | Output condition of 0.5 W | — | — | — | 0.42 | 0.16 | 0.18 | 0.08 | 0.10 |
| ratio (Sdr) | Output condition of 0.75 W | — | — | — | 0.44 | 0.27 | 0.26 | 0.11 | 0.17 |
| | Output condition of 1.0 W | — | — | — | 0.62 | 0.38 | 0.35 | 0.17 | 0.23 |
| | Output condition of 5.0 W | — | — | — | — | — | — | — | — |
| Protrusion height | Output condition of 0.5 W | mm | — | — | 6.75 | 2.00 | 1.12 | 2.34 | 2.35 |
| | Output condition of 0.75 W | mm | — | — | 9.36 | 2.63 | 0.94 | 2.67 | 2.93 |
| | Output condition of 1.0 W | mm | — | — | 11.78 | 3.34 | 0.83 | 2.67 | 3.98 |
| | Output condition of 5.0 W | mm | — | — | — | — | — | — | — |
| Glossiness | 60 degrees | % | 76.6 | 77.9 | 77.8 | 78.2 | 72.1 | 65.2 | 49.5 |

| | | | | | Comp. | Comp. | Comp. | Comp. |
|---|---|---|---|---|---|---|---|---|
| | | | Ex. 19 | Ex. 20 | Ex. 4 | Ex. 5 | Ex. 6 | Ex. 7 |
| Production Example | | | 23 | 24 | 12 | 24 | 12 | 25 |
| Mold temp. during injection molding | | °C | 80 | 80 | 80 | 80 | 80 | 80 |
| Tg | Viscoelasticity measurement | °C | 89 | 79 | 98 | 79 | 98 | 75 |
| Crystallization peak temp. | Cooling rate: 20 °C/min | °C | 220.6 | 192.3 | 209.3 | 192.3 | 209.3 | 193.1 |
| Transmittance (355 nm) | | % | 9.5 | 2.5 | 27.4 | 2.5 | 27.4 | 1.4 |
| Light reflectance (355 nm) | | % | 11.9 | 10.9 | 9.5 | 10.9 | 9.5 | 14.0 |
| Light absorptivity (355 nm) | | % | 78.6 | 86.6 | 63.1 | 86.6 | 63.1 | 84.6 |
| Laser marking conditions | Wavelength | nm | 355 | 355 | 1064 | 1064 | 10600 | 1064 |
| | Scanning rate | mm/sec | 1700 | 1700 | 1700 | 1700 | 1700 | 1700 |
| Lightness of unprinted portion (L*) | | — | 89.0 | 90.5 | 70.1 | 90.5 | 70.1 | 81.0 |
| Color difference: ΔE* | Output condition of 0.5 W | — | 19.5 | 24.4 | Not | Not | Not | — |
| | | | | | printable | printable | printable | |
| | Output condition of 0.75 W | — | 21.4 | 25.2 | Not | Not | Not | — |
| | | | | | printable | printable | printable | |
| | Output condition of 1.0 W | — | 19.2 | 27.5 | Not | Not | Not | — |
| | | | | | printable | printable | printable | |
| | Output condition of 5.0 W | — | — | — | — | — | — | 18.0 |
| Developped interfacial area | Output condition of 0.5 W | — | 0.17 | 0.34 | — | — | — | — |
| ratio (Sdr) | Output condition of 0.75 W | — | 0.26 | 0.50 | — | — | — | — |
| | Output condition of 1.0 W | — | 0.37 | 0.53 | — | — | — | — |
| | Output condition of 5.0 W | — | — | — | — | — | — | 2.20 |
| Protrusion height | Output condition of 0.5 W | mm | 0.08 | 2.52 | — | — | — | — |
| | Output condition of 0.75 W | mm | 0.38 | 3.82 | — | — | — | — |
| | Output condition of 1.0 W | mm | 1.75 | 4.11 | — | — | — | — |
| | Output condition of 5.0 W | mm | — | — | — | — | — | 4.50 |
| Glossiness | 60 degrees | % | 56.2 | 50.2 | 77.8 | 50.2 | 77.8 | 43.0 |

TABLE 5

| | | | Ex. 21 | Ex. 22 |
|---|---|---|---|---|
| Production Example | | | 14 | 19 |
| Mold temp. during injection molding | | °C | 80 | 80 |
| Tg | Viscoelasticity measurement | °C | 98 | 98 |
| Crystallization peak temp. | Cooling rate: 20 °C/min | °C | 208.5 | 211.0 |
| Transmittance (355 nm) | | % | 0.5 | 1.1 |
| Light reflectance (355 nm) | | % | 8.5 | 9.1 |
| Light absorptivity (355 nm) | | % | 91.0 | 89.8 |
| Laser marking conditions | Wavelength | nm | 355 | 355 |
| | Scanning rate | mm/sec | 1600 | 1100 |
| Lightness of unprinted portion (L*) | | — | 87.2 | 88.7 |
| Color difference: ΔE* | Output condition of 1.75 W | — | 18.6 | 21.0 |
| | Output condition of 2.00 W | — | 20.3 | 20.9 |
| | Output condition of 2.25 W | — | 18.8 | 20.7 |
| Developped interfacial area | Output condition of 1.75 W | — | 0.45 | 0.38 |
| ratio (Sdr) | Output condition of 2.00 W | — | 0.45 | 0.37 |
| | Output condition of 2.25 W | — | 0.51 | 0.39 |
| Protrusion height | Output condition of 1.75 W | mm | 2.94 | 2.10 |
| | Output condition of 2.00 W | mm | 2.73 | 2.65 |
| | Output condition of 2.25 W | mm | 2.93 | 2.86 |
| Glossiness | 60 degrees | % | 73.7 | 78.1 |

It was understood from Tables 3 to 5 that molded articles (Examples 1 to 22) that contained titanium dioxide (B-1) with an average particle size of 1 μm or less in an amount in the range of 0.5 parts by mass or more and 10.0 parts by mass or less per 100 parts by mass of the thermoplastic resin (A), had a light reflectance at 355 nm of 17% or less when the thickness was 50 μm, and had a protrusion height of the identification portion of 6.6 μm or less all exhibited excellent clarity in the printed portion made by laser marking.

On the other hand, in Comparative Examples 1 to 6, which did not meet these conditions, the clarity of the printed portion made by laser marking was poor.

The above results indicated that molded articles that contained titanium dioxide, had a light reflectance at a wavelength of 355 nm when the thickness was 50 μm, and had a protrusion height of the identification portion within a certain numerical range exhibited excellent clarity in the printed portion made by laser marking.

### INDUSTRIAL APPLICABILITY

According to the molded article and the manufacturing method of the present embodiment, molded articles with clearly printed markings made by laser marking can be obtained. The molded article of the present embodiment can be suitably used in various fields, including the automotive field, electrical and electronic fields, mechanical and manufacturing fields, office equipment field, and aerospace field.

1. A molded article formed by molding a resin composition that contains a thermoplastic resin (A) and titanium oxide (B) with an average particle size of 1 μm or less and is free of antimony-based oxides, the molded article comprising
an identification portion having a color tone different from a color tone of a surrounding portion,
wherein a light reflectance at a wavelength of 355 nm is 17% or less when the resin composition is molded into a molded product with a thickness of 50 μm, and
a protrusion height of the identification portion is 6.6 μm or less.

2. The molded article according to claim 1, wherein the thermoplastic resin (A) comprises a polyamide-based resin (A1) and/or a polyester-based resin (A2).

3. The molded article according to claim 2, wherein the polyamide-based resin (A1) is a semi-aromatic polyamide (A1-2) containing an aromatic ring in a backbone thereof, or an alloy of the semi-aromatic polyamide (A1-2) and an aliphatic polyamide (A1-1).

4. The molded article according to claim 3, wherein the semi-aromatic polyamide (A1-2) contains 10 mol % or more of isophthalic acid units per 100 mol % of a sum of all constituting dicarboxylic acid units.

5. The molded article according to claim 1, wherein a glass transition temperature of the resin composition is 90° C. or higher.

6. The molded article according to claim 1, wherein a crystallization peak temperature of the resin composition is 240° C. or lower.

7. The molded article according to claim 1, wherein the resin composition further comprises a filler (C).

8. The molded article according to claim 7, wherein the resin composition contains the filler (C) in an amount of more than 0.0 parts by mass and 150.0 parts by mass or less per 100 parts by mass of the thermoplastic resin (A).

9. The molded article according to claim 7, wherein the filler (C) is at least one selected from the group consisting of glass fibers, calcium carbonate, talc, mica, wollastonite, and milled fiber.

10. The molded article according to claim 1, wherein the resin composition further comprises a flame retardant (D).

11. The molded article according to claim 10, wherein the flame retardant (D) is at least one selected from the group consisting of a phosphinate salt and a diphosphinate salt.

12. The molded article according to claim 11, wherein the phosphinate salt is a compound represented by the following formula (I), and the diphosphinate salt is a compound represented by the following formula (II): 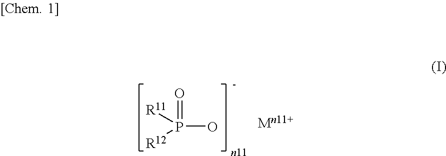
in the formula (I), R¹¹ and R¹² are each independently an alkyl group with 1 or more and 6 or fewer carbon atoms or an aryl group with 6 or more and 10 or fewer carbon atoms, Mⁿ¹¹⁺ is an n11-valent metal ion, M is an element belonging to Group 2 or Group 15 of the periodic table, a transition element, zinc, or aluminum, n11 is 2 or 3, and respective occurrences of R¹¹ and R¹² may each be identical or different, and 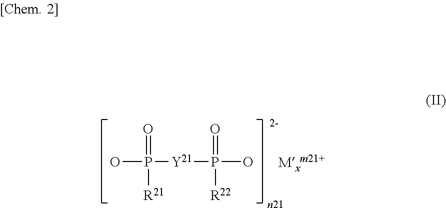
in the formula (II), R²¹ and R²² are each independently an alkyl group with 1 or more and 6 or fewer carbon atoms or an aryl group with 6 or more and 10 or fewer carbon atoms, Y²¹ is an alkylene group with 1 or more and 10 or fewer carbon atoms or an arylene group with 6 or more and 10 or fewer carbon atoms, M′ₓ^{m21+} is an m21-valent metal ion, M′ is an element belonging to Group 2 or Group 15 of the periodic table, a transition element, zinc, or aluminum, n21 is an integer of 1 or more and 3 or less, when n21 is 2 or 3, respective occurrences of R²¹, R²² and Y²¹ may each be identical or different, m21 is 2 or 3, x is 1 or 2, when x is 2, occurrences of M′ may each be identical or different, and n21, x, and m21 are integers that satisfy the relationship formula: 2×n21=m21×x.

13. The molded article according to claim 1, wherein the resin composition comprises a colorant (E), and a lightness (L* value) of the molded article is 25 or more.

14. The molded article according to claim 1, wherein the resin composition contains the titanium oxide (B) in an amount of 0.5 parts by mass or more and 10.0 parts by mass or less per 100 parts by mass of the thermoplastic resin (A).

15. The molded article according to claim 1, wherein a developed interfacial area ratio Sdr of an interface as defined in ISO 25178 of the identification portion is 0.01 or more and 2.00 or less.

16. The molded article according to claim 1, wherein the molded article is a housing for a magnetic switch, a housing for a breaker, or a molded article for a connector.

17. A method for manufacturing a laser-marked molded article comprising:
performing laser marking on a molded article formed by molding a resin composition containing a thermoplastic resin (A),
wherein the resin composition is a composition having a light reflectance at a wavelength of 355 nm of 17% or less when formed into a molded product with a thickness of 50 μm.

18. A method of laser marking a molded article formed by molding a resin composition containing a thermoplastic resin (A),
wherein the resin composition is a composition having a light reflectance at a wavelength of 355 nm of 17% or less when formed into a molded product with a thickness of 50 μm.
